(19) United States
(12) Patent Application Publication
(10) Pub. No.: US 2020/0327481 A1
(43) Pub. Date: Oct. 15, 2020

(54) METHODS AND APPARATUS FOR OPTIMIZING WELL TESTING OPERATIONS

(71) Applicant: Schlumberger Technology Corporation, Sugar Land, TX (US)

(72) Inventor: Francis Dominique Allouche, Clamart (FR)

(21) Appl. No.: 16/623,438

(22) PCT Filed: Jun. 27, 2018
(86) PCT No.: PCT/US2018/039627

§ 371 Date: Dec. 17, 2019

(30) Foreign Application Priority Data
Jun. 27, 2017 (EP) 17290084.7

(51) Int. Cl. G06Q 10/06; E21B 49/08; E21B 47/12

(52) U.S. Cl. CPC G06Q 10/063116; E21B 47/12; E21B 49/088

(57) ABSTRACT

Methods and apparatus for optimizing well testing operations are disclosed herein. An example apparatus includes an optimizer to generate a first workflow to be executed by a first user during a well test at a well. The example apparatus includes a workflow adjuster to selectively adjust at least one of the first workflow to generate a first adjusted workflow or a second workflow to generate a second adjusted workflow based on a notice indicative of an unplanned event at the well. The second workflow is to be associated with a second user or a well test device. The example apparatus includes a communicator to transmit one or more of the first adjusted workflow to a user device or the second adjusted workflow to a user device or the well test device during the well test.

### BACKGROUND

This disclosure relates generally to well testing and, more particularly, to methods and apparatus for optimizing well testing operations.

### Description of the Related Art

Well tests may be performed to assess a hydrocarbon reservoir to define characteristics such as rock permeability, production index, and/or volume of hydrocarbons. Such characteristics, in combination with fluid analysis, serve as factors in deciding whether to put a well in production. Performing a well test includes operating well testing equipment at the surface (e.g., choke manifolds, valves, operators, heaters, etc.) to control production fluid flowrates, separate multiphase fluids, collect fluid samples, obtain measurements, etc. In some examples, tasks to be performed during the well test are automated tasks that can be executed by the well testing equipment. In other examples, one or more tasks are performed manually by an operator. In some examples, a crew of operators is deployed at a wellsite to perform different tasks during the well test.

During a well test, unexpected events can occur that require tasks to be performed to, for example, mitigate the unexpected events. The unexpected events can include, for example, leaks, surge flow, choke plugging, etc. In such examples, an operator may be interrupted from performing a planned task to perform additional task(s) based on the unexpected event.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

An example apparatus includes an optimizer to generate a first workflow to be executed by a first user during a well test at a well. The example apparatus includes a workflow adjuster to selectively adjust at least one of the first workflow to generate a first adjusted workflow or a second workflow to generate a second adjusted workflow based on a notice indicative of an unplanned event at the well. The second workflow is to be associated with a second user or a well test device. The example apparatus includes a communicator to transmit one or more of the first adjusted workflow to a user device or the second adjusted workflow to a user device or the well test device during the well test.

An example method includes generating a first workflow to be executed by a first user during a well test at a well. The example method includes selectively adjusting at least one of the first workflow to generate a first adjusted workflow or a second workflow to generate a second adjusted workflow based on a notice indicative of an unplanned event at the well. The second workflow is to be associated with a second user or a well test device. The example method includes transmitting one or more of the first adjusted workflow to a user device or the second adjusted workflow to a user device or the well test device during the well test.

An example non-transitory computer readable medium includes instructions that, when executed, cause a machine to generate a first workflow to be executed by a first user during a well test at a well. The instructions cause the machine to selectively adjust at least one of the first workflow to generate a first adjusted workflow or a second workflow to generate a second adjusted workflow based on a notice indicative of an unplanned event at the well. The second workflow is to be associated with a second user or a well test device. The instructions cause the machine to transmit one or more of the first adjusted workflow to a user device or the second adjusted workflow to a user device or the well test device during the well test.

Various refinements of the features noted above may exist in relation to various aspects of the present embodiments. Further features may also be incorporated in these various aspects. These refinements and additional features may exist individually or in any combination. For instance, various features discussed below in relation to the illustrated embodiments may be incorporated into any of the above-described aspects of the present disclosure alone or in any combination. Again, the brief summary presented above is intended to familiarize the reader with certain aspects and contexts of some embodiments without limitation to the claimed subject matter.

### BRIEF DESCRIPTION OF THE DRAWINGS

FIG. 1 illustrates an example system for automatically scheduling operator task(s) and/or well testing device task(s) to be performed during well testing at a well in accordance with the teachings of this disclosure.

FIG. 2 is a block diagram of an example implementation of the job planner of FIG. 1.

FIG. 3 is a diagram illustrating example task allocation scenarios generated by the example job planner of FIG. 2.

FIGS. 4-6 are graphs illustrating example workflows generated by the example job planner of FIG. 2.

FIG. 7 is an example graph including support availability data generated by the example job planner of FIG. 2.

FIG. 8 is a block diagram of an example implementation of the job scheduler of FIG. 1.

FIG. 9 is a diagram illustrating example workflow adjustment scenarios generated by the example job scheduler of FIG. 8.

FIG. 10 is a flowchart representative of example machine readable instructions that may be executed to implement the example job planner of FIG. 2.

FIG. 11 is a flowchart representative of example machine readable instructions that may be executed to implement the example job scheduler of FIG. 8.

FIG. 12 illustrates a first example processor platform that may execute one or more of the example instructions of FIG. 10 to implement the example job planner of FIG. 2.

FIG. 13 illustrates a first example processor platform that may execute one or more of the example instructions of FIG. 11 to implement the example job scheduler of FIG. 8.

The figures are not to scale. Wherever possible, the same reference numbers will be used throughout the drawing(s) and accompanying written description to refer to the same or like parts.

### DETAILED DESCRIPTION

It is to be understood that the present disclosure provides many different embodiments, or examples, for implementing different features of various embodiments. Specific examples of components and arrangements are described below for purposes of explanation and to simplify the present disclosure. These are, of course, merely examples and are not intended to be limiting.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements.

Well tests may be performed to assess a hydrocarbon reservoir to define characteristics such as rock permeability, production index, and/or volume of hydrocarbons. Such characteristics, in combination with fluid analysis, serve as factors in deciding whether to put a well in production. Execution of a well test includes a variety of tasks to be performed to, for example control well pressure, heat production fluid, separate multiphase fluid for analysis, store portions of the fluid (e.g., oil), etc. The well test tasks can include automated tasks to be performed by one or more well testing devices (e.g., choke manifolds, separators, burners, etc.) and manual tasks to be performed by crew members (e.g., operators) deployed at the wellsite and/or in a lab. The manual tasks can include, for example, managing and/or monitoring the performance of the well testing device(s), collecting measurements, etc. In some examples, an operator is to perform a series of sequential tasks during a well test, such as opening a valve, collecting a sample, closing the valve, etc.

During a well test, unexpected or unplanned events can occur, such as leaks, surge flow, choke plugging, changes in wind direction, etc. Thus, although an operator may plan to perform one or more tasks, in some examples, the operator is interrupted from performing a planned task to perform other task(s) based on the unexpected event(s). For example, the operator may have to address technical errors at a well testing device, re-collect a sample if the sample is not of adequate quality, delay performance of a task based on well conditions, etc. The unplanned events vary from well test to well test and can occur at different times within a well test and/or between well tests. Also, different tasks may be required to mitigate different unplanned events and the mitigation tasks can vary in complexity, duration to completion, etc. Some well test tasks have been automated and/or optimized with respect to performance of the tasks and/or scheduling of the tasks. However, known examples do not dynamically respond to unexpected events that can arise from a variety of sources (e.g., well conditions, user activities) during a well test.

Example apparatus, systems, and methods disclosed herein provide for automatic scheduling of well test tasks to be performed by one or more users (e.g., operators) and/or well testing devices. Some examples disclosed herein generate workflow(s) that include manual task(s) to be performed by the user(s) and/or automated task(s) to be performed by the well testing device(s). Example workflow(s) disclosed herein include a sequence in which the task(s) should be performed, a time at which the task(s) should be performed, etc. Some examples disclosed herein generate the workflow(s) based on the tasks to be performed, a number of users (e.g., crew size), qualifications of the users, and/or conditions at the well.

Some examples disclosed herein generate the workflows by optimizing the allocation of tasks to the user(s) and/or well testing device(s) to, for example minimize a number of user(s) performing the tasks to reduce resources and to increase efficiency in the completion of the tasks. Some disclosed examples optimize an availability of the users such that the users are assigned tasks to efficiently use resources while providing for at least one or more users to be available during the well test to provide support and/or to perform mitigation tasks should an unplanned event occur. Thus, disclosed examples generate a workflow that provides for efficiency in completing the well test and an ability to effectively respond to unplanned events to minimize disruptions to the successful completion of the well test.

Some disclosed examples monitor the execution of the workflow(s) by the user(s) and/or the well testing device(s) in substantially real-time during the well test. Based on feedback received from the user(s) and/or the well testing device(s), disclosed examples recognize disruptions to the workflow(s), such as delays in task completion and/or the occurrence of unplanned events. Some disclosed examples dynamically adjust the workflow(s) to mitigate disruptions due to unplanned events and/or to compensate for task completion delays to enable the well test to be completed within a predefined time period. Some disclosed examples consider factors such as user availability, user qualifications, etc. to selectively adjust the workflow(s). In examples disclosed herein, the adjusted workflow(s) are provided to the user(s) and/or the well testing device(s) in substantially real-time during the well test to continue the efficient execution of the well test. Further, although examples are discussed herein in the context of well testing, such examples are not limited to well testing and can be implemented in other environments.

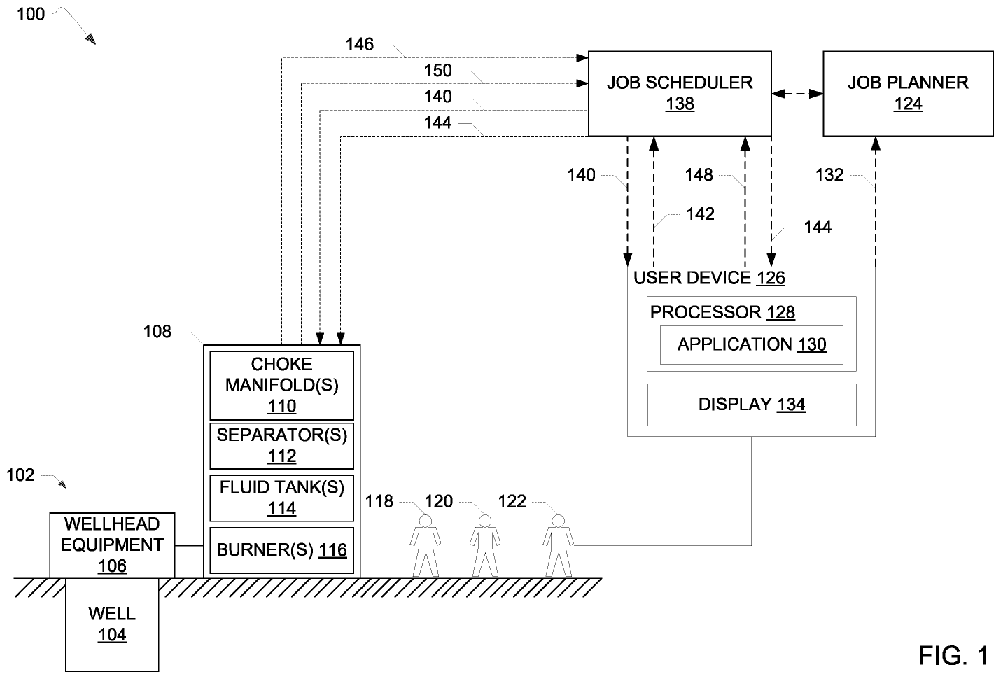

FIG. 1 illustrates an example system 100 for optimizing the scheduling of automated and/or manual tasks to be performed during a well test in accordance with the teachings of this disclosure. The example system 100 can be implemented at any wellsite 102. The wellsite 102 of FIG. 1 includes a well 104 and wellhead equipment 106 such as casing head(s), tubing head(s), a production tree, etc. installed at the surface of the wellsite 102. The wellsite 102 includes one or more well testing devices 108 coupled to the wellhead equipment 106 at the surface. In the example of FIG. 1, fluid produced from the well 104 is routed through the wellhead equipment 106 to the well testing device(s) 108 for analysis. The well testing device(s) 108 can include, for example, choke manifold(s) 110 for receiving and routing fluid received from the well 104, separator(s) 112 for separating multiphase fluid (e.g., oil, gas, water), fluid tank(s) 114 to store the fluid, and burner(s) 116 for burning oil and gas. The example well testing device(s) 108 of FIG. 1 can include other types of devices to perform the well test.

In the example of FIG. 1, a first user 118, a second user 120, and a third user 122 are deployed at the wellsite. The user(s) 118, 120, 122 can include members of a crew (e.g., operators) who each perform one or more tasks at the surface during testing of the well 104. For example, the first user 118 may manage the choke manifold(s) 110 and collect measurements at the choke manifold(s) 110 such as basic sediment and water content, liquid density, gas specific gravity, etc. The second user 120 may manage the fluid tank(s) 114 (e.g., the associated pump(s)), measure tank level(s), and check the burner(s) 116. The third user 122 may be a supervisor who operates the separator(s) 112 and supervises the first user 118 and/or the second user 120. Additional or fewer users (e.g., crew members) can be present at the wellsite 102.

In the example of FIG. 1, the user(s) 118, 120, 122 perform their respective task(s) based on individual workflow(s) (e.g., work plan(s), schedule(s)) that set forth the task(s) to be performed by each user during well testing and the sequence for performing the task(s). In some examples, one or more of the well testing device(s) 108 perform automated task(s) based on workflow(s). In the example of the FIG. 1, the workflow(s) are generated by a job planner 124. In some examples, the example job planner 124 is implemented by processor(s) of one or more user device(s) (e.g., smartphone(s), tablet(s), personal computer(s)). In some such examples, the user device(s) that implement the job planner 124 are disposed at the wellsite 102 and/or are disposed at location(s) separate from the wellsite 102 (e.g., a laboratory). In other examples, the job planner 124 is implemented by one or more cloud-based device(s) such as one or more server(s), processor(s), and/or virtual machine(s). In other examples, some of the analysis performed by the job planner 124 is implemented by the cloud-based device(s) and other parts of the analysis are implemented by the processor(s) of the user device(s).

As disclosed herein, the example job planner 124 of FIG. 1 automatically generates the workflow(s) based on user input(s) defining, for example, the tasks to be performed, a number of crew members to perform the task(s), characteristics of the well 104, phase(s) of the well testing, etc. The example job planner 124 allocates the tasks to the user(s) (e.g., crew members) and/or the well testing device(s) and generates the workflow(s) by balancing factors such as a minimum number of crew members needed to complete the tasks, estimated times to complete the tasks, availability of crew member(s) and/or device(s) to perform unplanned tasks during the well testing, crew safety, etc.

The example system 100 of FIG. 1 includes one or more user devices for use by one or more of the users 118, 120, 122. For illustrative purposes, a user device 126 of the third user 122 (e.g., a supervisor) is shown in FIG. 1 with the understanding that user devices can be associated with any of the first, second, or third users 118, 120, 122. The example user device 126 of FIG. 1 can be implemented by a smartphone, a tablet, a personal computer, etc.

The example user device 126 of FIG. 1 includes a processor 128 to execute a user application 130. In the example of FIG. 1, the third user 122 accesses the user application 130 via a display 134 of the user device 126 to provide one or more user inputs 132 that are used by the job planner 124 to generate workflow schedule(s) for the user(s) 118, 120, 122 and/or the well testing device(s) 108. The processor 128 of the user device 126 can communicate with the job planner 124 via one or more wired or wireless connections (e.g., WiFi, Bluetooth) to transmit the user input(s) 132 to the job planner 124. In some examples, the user input(s) 126 are provided to the job planner 124 via a user device different than the user device 126 of FIG. 1 (e.g., by a personal computer not located at the wellsite 102) and/or by a cloud-based device.

The user input(s) 132 include, for example, a list of the task(s) to be completed during well testing, action(s) to be performed during each task (e.g., a combination of steps to complete the task), the number of users and/or well testing devices available to perform the task(s), and a time period in which the task(s) are to be completed (e.g., a well testing time period). In some examples, the user input(s) 132 include information about the user(s) 118, 120, 122, such as qualifications and training levels for each user. In some examples, the user input(s) 132 include characteristics about the well 104 and/or the types of well tests to be performed (e.g., exploration, appraisal). The user input(s) 132 can include customized inputs such as preferred measurements to be obtained during the well test, frequencies at which the measurements are to be collected, etc.

The example job planner 124 of FIG. 1 uses the user input(s) 132 and one or more optimization algorithms or rules to allocate tasks to each of the users 118, 120, 122 and/or the well testing device(s) 108. The example job planner 124 generates workflows 140 for the user(s) and/or the well testing device(s). The workflow(s) 140 include the tasks to be performed and the order in which the tasks are to be performed over a particular time period. The example job planner 124 generates the workflow(s) 140 to provide for efficient completion of the tasks using a minimum number of crew members (e.g., user(s) 118, 120, 122) in view of factors such as crew safety, expected times to complete the tasks, well conditions, etc. In some examples, the job planner 124 generates the workflow(s) 140 including automated tasks to be performed by one or more of the well testing device(s) 108.

In some examples, when allocating the tasks to the user(s) and generating the workflow(s) 140, the job planner 124 of FIG. 1 considers the availability of the user(s) to perform additional tasks due to the occurrence of unexpected or unplanned event(s) during the well test. Unexpected or unplanned event(s) can include, for example, surge flow, slug flow, overpressure at a given depth in the well 104, and/or other conditions that may affect the flow of fluid from the well 104. Because the unexpected events are not planned well test events, the unexpected events are not initially provided to the job planner 124 (e.g., via the user input(s) 132 that are used to generate the workflow(s) 140). However, when generating the workflow(s) 140, the example job planner 124 automatically accounts for the risk that unexpected event(s) may occur that require at least one user to be available to perform additional task(s). For example, the job planner 124 can allocate a task to the first user 118 to be performed at the first time while refraining from allocating a task to the second user 120 during the first time so that the second user 120 is available to provide support should an unexpected event should occur during the first time.

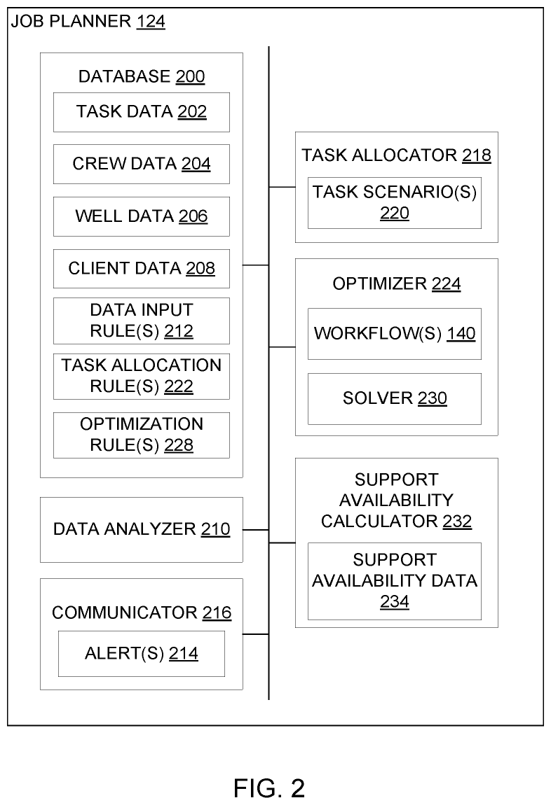

The example system 100 of FIG. 2 also includes a job scheduler 138. The example job scheduler 138 of FIG. 1 monitors the workflow(s) 140 in substantially real-time during execution of the workflow(s) 140 by the user(s) 118, 120, 122 and/or the well testing device(s) 108. Based on the monitoring, the example job scheduler 138 determines whether the workflow(s) should be adjusted and, if so, dynamically adjusts the workflow(s) 140 in substantially real-time during the well test time period. In some examples, the job scheduler 138 automatically adjusts the workflow(s) 140 for one or more users to mitigate unplanned events at the wellsite 102, compensate for delays in task completion, etc.

The example job scheduler 138 is implemented by processor(s) of one or more user device(s) (e.g., smartphone(s), tablet(s), personal computer(s)). In other examples, the job scheduler 138 is implemented by one or more cloud-based device(s) such as one or more server(s), processor(s), and/or virtual machine(s). In other examples, some of the analysis performed by the job scheduler 138 is implemented by the cloud-based device(s) and other parts of the analysis are implemented by processor(s) of the user device(s). In some examples, the job planner 124 and the job scheduler 138 are implemented by the same processor. In some examples, one or more components of the job planner 124 and/or one or more components of the job scheduler 138 are implemented by two or more processors

The example job planner 124 transmits the workflow(s) 140 to the job scheduler 138 for delivery to the user device(s) 126 and/or the well testing device(s) 108 in substantially real-time during the well test. In some examples, the job planner 124 generates the workflow(s) 140 based on the user input(s) 132 received prior to the start of the well test. For example, the third user 122 can provide the user input(s) 132 via the user application 130 of the user device 126 (or another user device) in anticipation of a planned well test at the well 104. The example job scheduler 138 then transmits the workflow(s) 140 for presentation via the display 134 of the user device 126 in substantially real-time during the well test (e.g., via WiFi). In some examples, all of the task(s) of the workflow(s) 140 are displayed to the user via the display 134 of the user device 126. In other examples, the task(s) to be performed are selectively displayed based on a particular time at which the task is to be performed, an order in which the task(s) are to be performed, etc. In examples where the workflow(s) 140 include automated task(s) to be performed by the well testing device(s) 108, the job scheduler 138 transmits the workflow(s) 140 to, for example, respective processor(s) associated with the well testing device(s) 108 (e.g., via WiFi).

During the well test, the user(s) 118, 120, 122 perform task(s) according to the respective workflow(s) 140 assigned to each user 118, 120, 122. In the example of FIG. 1, each time a task is completed, the user (e.g., the third user 122) inputs a user task notice 142 via the user application 130 of the user device 126 (or another user device). In examples where the tasks are selectively displayed via the user device 126 (e.g., in an order in which the tasks are to be performed), the next task in the workflow may be displayed after the task has been marked complete based on the user task notice 142.

The example job scheduler 138 analyzes the user task notice(s) 142 in substantially real-time to determine if any adjustments are needed to the workflow(s) 140. For example, the job scheduler 138 may determine that a workflow 140 assigned to the third user 122 needs to be adjusted if a duration of time for the third user 122 to complete a first task in the workflow 140 was longer than the job planner 124 expected when creating the workflow 140. In such examples, the job scheduler 138 generates an adjusted workflow 144 for the third user 122. The adjusted workflow 144 can include, for example, a different task for the third user 122 to perform after the first task than originally planned by the job planner 124 or include fewer task(s) for third user 122 to perform to account for the longer than expected time to complete the first task. The adjusted workflow(s) 144 are transmitted by the job scheduler 138 for presentation via the display 134 of the user device 126.

As disclosed above, in some examples, the tasks to be performed during the well test include automated tasks to be performed by one or more the well testing devices 108 (e.g., the choke manifold(s) 110 the separator(s) 112, the burner(s) 116). In the example of FIG. 1, one or more of the well testing device(s) 108 are in communication with the job scheduler 138 (e.g., wireless communication with processor(s) associated with the well testing device(s) 108). The well testing device(s) 108 automatically send automated task notice(s) 146 to the job scheduler 138 confirming that a task has been completed by the corresponding well testing device. For example, a sensor may determine that the choke manifold 110 is closed, which causes a processor associated with the choke manifold 110 to send an automated task notice 146 indicating that a valve closure task has been completed.

The example job scheduler 138 analyzes the automated task notice(s) 146 received from the well testing devices to determine if the workflow(s) 140 for the well testing device(s) (and, in some examples, the user(s)) should be adjusted. In some such examples, the job scheduler 138 generates the adjusted workflow(s) 144 if, for example, the job scheduler 138 does not receive an automated task notice 146 from a well test device within an expected period of time based on the workflow 140 for the device. In some examples, the job scheduler 138 determines if the workflow(s) 140 for the well testing device(s) 108 should be adjusted based on the user task notice(s) 142 received via the user device 126 and/or the automated task notice(s) 146 received from the well testing device(s) 108.

In some examples, one or more unplanned events occur during well testing. The unplanned event(s) can include an error and/or delay in the performance of a task by a user, a failure of the task to be completed, a problem at the well 104 (e.g., slug flow), a problem with the well test device(s) 108, a problem with the measurements collected (e.g., the measurements indicate that additional measurements should be collected), etc. In the example of FIG. 1, the third user 122 enters one or more issue notices 148 via the user application 130 to indicate that one or more unplanned events have occurred. In some examples, the issue notice(s) 148 are selected by the third user 122 from a predefined list of unplanned events provided by the user application 130.

In examples where the unplanned event(s) occur at the well testing device(s) 108, the well testing device(s) 108 transmit automated issue notice(s) 150 to the job scheduler 138. The well testing device(s) 108 can include sensor(s) that trigger the transmission of the automated issue notice(s) 150 to the job scheduler 138 if the sensor(s) detect that an error has occurred. For example, a pressure sensor of the fluid tank 114 may determine that a pressure level in the tank exceeds a predefined threshold pressure. As a result, a processor associated with the fluid tank 114 sends an automated issue notice 150 indicating the pressure level issue at the fluid tank 114 to the job scheduler 138.

The example job scheduler 138 analyzes the issue notice(s) 148 received via the user device 126 and/or the automated issue notice(s) 150 received from the well testing device(s) 108. In some examples, the issue notice(s) 148, 150 include a mitigation task to be performed to address the unplanned event (e.g., as defined by the user). In other examples, the job scheduler 138 automatically determines one or more mitigation tasks to be added to the workflow(s) 140 for one or more of the user(s) 118, 120, 122 to address the unplanned event(s). In some examples, the job scheduler 138 re-plans the workflow(s) 140 based on one or more of the unplanned event(s), the task(s) to be performed to address the unplanned event(s), other task(s) in the workflow(s) 140 to be completed (e.g., previously planned task(s)), the availability and/or qualifications of the user(s) 118, 120, 122 to complete the mitigation task(s), etc. The job scheduler 138 generates adjusted workflow(s) 144 including the mitigation task(s) in view of the unplanned event(s) and transmits the adjusted workflow(s) 144 for presentation via the display 134 of the user device 126 and/or to the well testing device(s) 108. In some examples, all of the tasks of the adjusted workflow(s) 144 are displayed such that the user views a new workflow including the mitigation task(s). In other examples, the tasks of the adjusted workflow(s) 144 are selectively displayed based on the time at which the tasks are to completed, whether a preceding task has been marked complete, etc.

Thus, the example job scheduler 138 of FIG. 1 monitors the performance of the task(s) by the user(s) 118, 120, 122 and/or the well testing device(s) 108 and evaluates the workflow(s) 140 in substantially real-time to determine whether the workflow(s) 140 should be adjusted. The job scheduler 138 dynamically adjusts the workflow(s) 140 to accommodate unplanned events, delays in completion of the task(s), etc. Thus, the job scheduler 138 provides for mitigation of unplanned events and/or task delays in an effort to provide for efficient completion of the tasks within the well testing time period.

FIG. 2 is a block diagram of an example implementation of the job planner 124 of FIG. 1. As mentioned above, the job planner 124 is constructed to generate one or more workflows including tasks to be performed by user(s) (e.g., the user(s) 118, 120, 122 of FIG. 1) and/or well testing device(s) (e.g., the well testing device(s) 108 of FIG. 1) during a well test. In the example of FIG. 2, the job planner 124 is implemented by a processor (e.g., a processor of a user device, one or more cloud-based devices, etc.).

The example job planner 124 includes a database 200. In other examples, the database 200 is located external to the job planner 124 in a location accessible to the job planner 124. The example database 200 provides means for storing data including well testing tasks(s), the crew to perform the task(s), well conditions (e.g., at the well 104 of FIG. 1), and/or other user-defined task criteria (e.g., particular measurements to be obtained). The data stored in the database 200 of FIG. 2 can include the user input(s) 132 received from via the user application 130 of the user device 126 of FIG. 1.

The example database 200 of FIG. 2 stores task data 202 (e.g., received via the user input(s) 132 of FIG. 1). The example task data 202 includes the tasks to be completed during the well test by one or more users and/or one or more well testing device(s). In some examples, the task data 202 includes two or more actions to be performed to complete a task (e.g., monitoring data for a period of time before collecting measurements). The task data 202 can include a time period over which the task(s) are to be completed (e.g., a well testing time period) and/or duration(s) of time to complete the task(s) (e.g., average durations, expected durations, etc.). The task data 202 can include a number of crew members assigned to perform the task (e.g., a minimum number of crew members to perform a particular task, a preferred number of crew members, etc.). The task data 202 can include transition time periods and/or delays to be implemented between tasks (e.g., a minimum time delay between tasks). The task data 202 can indicate whether the task includes a wait period, such a wait period for sample fluid including sediment to settle. The task data 202 can include other information about the tasks, such as a sequence (e.g., a preferred sequence) in which the tasks are to be performed and a relationship between two or more tasks (e.g., whether performing a first task is a prerequisite to performing a second task).

The example database 200 of FIG. 2 stores crew data 204 (e.g., received via the user input(s) 132 of FIG. 1). The example crew data 204 includes a size of the crew (e.g., a number of user(s) 118, 120, 122). The crew data 204 can include training levels and/or qualification levels for each member of the crew to perform the tasks in the task data 202. In some examples, the crew data 204 includes designated user(s) and/or designated back-up user(s) to perform specific task(s).

The example database 200 of FIG. 2 stores well data 206 (e.g., received via the user input(s) 132 of FIG. 1). The example well data 206 includes the type of well test to be performed (e.g., exploration, appraisal, development, etc.), a specific phase of the well test (e.g., flow period, cleanup, etc.), characteristics of the well testing device(s) 108 (e.g., a number of manifolds), an expected flow rate, etc. The well test data 206 can include technical specifications for the well testing device(s) 108.

The example database 200 of FIG. 2 stores client data 208 (e.g., received via the user input(s) 132 of FIG. 1). The example client data 208 includes user-defined criteria, such as a frequency of the tasks(s) to be performed, the types of measurements to be collected, etc. In some examples, the client data 208 includes changes to, for example, a predefined frequency for collecting a particular measurement based on user preferences.

As disclosed herein, in some examples, the task data 202, the crew data 204, the well data 206, and/or the client data 208 are defined by user input(s) entered at, for example, the user application 130 of FIG. 1. In some examples, the data is entered by the user via one or more menus or fields displayed via the user application 130.

The example job planner 124 includes a data analyzer 210. The data analyzer 210 analyzes the data received from the user application 130 (e.g., the task data 202, the crew data 204, the well data 206, the client data 208) to determine time constraints and/or resource constraints for the tasks to be performed during the well test. For example, based on the data 202, 204, 206, 208, the data analyzer 210 determines the well testing time period, the number of users to perform tasks based on qualification and/or training levels, etc.

The data analyzer 210 analyzes the data 202, 204, 206, 208 to determine the time and/or resource constraints based on one or more data input rules 212. For example, the data analyzer 210 can determine a frequency at which a task should be performed based on the type of well test to be performed (e.g., as provided by the well data 206). The data input rule(s) 212 can be defined by user input(s) and/or generated by the data analyzer 210 based on historical data (e.g., a frequency at which the task was performed in the past for the same type of well test). In some examples, the data analyzer 210 defers to the client data 208 if, for example, the client data 208 indicates that the user would like a task to be completed with increased or reduced frequency as compared to the frequency calculated by the data analyzer 210 based on the data input rule(s) 212.

In some examples, the data analyzer 210 analyzes the task data 202, the crew data 204, the well data 206, and/or the client data 208 to determine if any of the tasks to be performed can be automated by the well testing device(s) 108 of FIG. 1 and/or do not require monitoring (e.g., substantially continuous monitoring) by a user. The data analyzer 210 can determine time constraints based on whether any of the tasks can be automated.

In some examples, the data analyzer 210 analyzes the task data 202, the crew data 204, the well data 206, and/or the client data 208 to determine if there are a sufficient number of users (e.g., crew members) to perform the task(s) within the well testing time period. In some examples, the data analyzer 210 determines if there are enough users to perform the task(s) based on user safety criteria defined by the data input rule(s) 212 (e.g., a minimum number of user(s) to perform a task based on industry safety standards). In some examples, the data input rule(s) 212 define a number of users to be available to provide backup support in the event a user is not able to perform a task and/or an unplanned event occurs.

In some examples, if the data analyzer 210 determines that there are not enough users to perform the task(s), the data analyzer 210 generates one or more alert(s) 214. In the example of FIG. 2, the alert(s) 214 are transmitted (e.g., via WiFi) to one or more user devices via a communicator 216 of the job planner 124.

The example job planner 124 of FIG. 2 includes a task allocator 218. The example task allocator 218 of FIG. 2 generates one or more task scenarios 220 based on task allocation rule(s) 222 and one or more of the task data 202, the crew data 204, the well data 206, and/or the client data 208. The task allocation rule(s) 222 can be defined by user input(s) and/or by the task allocator 218 based on historical data. The task allocation rule(s) 222 are stored in the database 200.

The example task allocation rule(s) 222 include algorithms and/or rules for allocating each of the tasks to be performed as provided in the task data 202 to a user and/or a well testing device based on the criteria defined by the crew data 204, the well data 206, and/or the client data 208. For example, the task allocation rule(s) 222 can define particular tasks to be performed by a user with a particular qualification level and/or tasks that should not be performed by the user based on his or her qualification level. The task allocation rule(s) 222 can include an average time to be allocated for completion of task (e.g., based on historical task data). In some examples, the task allocation rule(s) 222 are based on the analysis performed by the data analyzer 210, such as a determination that one or more tasks can be automated.

The task scenario(s) 220 include the task(s) to be performed by the user(s) and/or well testing device(s) 108 over the well testing time period. Each task scenario 220 includes the particular tasks to be performed by the user and the time at which each task is to be performed by the user based on the resource and/or time constraints determined by the data analyzer 210. In some examples, the task allocator 218 generates multiple task scenarios 220 for each user that include one or more variations between the task(s) to be performed by the user, the time(s) at which the task(s) are to be performed, the time(s) at which the user is not allocated a task, etc. Thus, in some examples, the task allocator 218 determines a plurality of user task scenarios 220 (e.g., substantially all possible user task scenarios) for the user(s) and/or the well testing device(s) 108.

The example job planner 124 of FIG. 2 includes an optimizer 224. The example optimizer 224 analyzes the task scenario(s) 220 generated by the task allocator 218 based on the resource and/or time constraints determined by the data analyzer 210. The example optimizer 224 generates the workflow(s) 140 for the user(s) 118, 120, 122 and/or the well testing device(s) 108 that provide for (1) the task(s) to be completed by a minimum number of users to increase efficiency of the well testing and to maximize resources while (2) minimizing instances in which all users are busy at the same time to provide for adequate support availability should an unplanned event occur.

The example optimizer 224 applies one or more optimization rules (e.g., algorithms) 228 to determine the workflow(s) 140. In some examples, the optimizer 224 uses job shop optimization algorithms to determine the workflow(s) 140 in view of the time constraint(s) (e.g., the well testing time period, length of time to complete a task) and resources constraint(s) (e.g., number of users, number of well testing device(s) 108) associated with the well testing tasks to be completed. In applying a job shop optimization, the optimizer 224 determines a sequence of tasks to be performed in a workflow that minimizes inefficiencies in time and/or resource usage.

In the example of FIG. 2, the optimizer 224 uses one or more parameters from the task data 202, the crew data 204, the well data 206, and/or the client data 208 to solve the job shop optimization. In some examples, for a given task, the optimizer 224 accounts for a length of time to complete the task (e.g., an expected duration of time, an average duration of time), a frequency at which the task is to be performed, a number of users to perform the task, and/or link(s) of the task with other task(s) (e.g., task(s) the proceed or follow). The example optimizer 224 of FIG. 2 treats a starting time of the task as a variable in generating the workflow(s) 140.

The example optimizer 224 uses a solver 230 to perform the optimization to generate the workflow(s) 140. The example solver 230 considers the following definitions when performing the optimization:

N: the number of activities to be scheduled;

M: the number of available resources (e.g., a number of users 118, 120, 122, a number of well testing device(s) 108);

P: an execution time vector where the i^{th} component represents an enforcement activity duration of a task number i;

E: a set of temporal constraints composed by activity indices pairs where if (i,j) ∈ E, then the i^{th} activity precedes the i^{th} activity;

b: a matrix of resources having a particular size (e.g., a size (N+2)×M), where the term b_{i,k} represents the amount of a resource k used by the i^{th} activity over a period in which the i^{th} activity is implemented (in a given matrix b, 1 represents that a user is busy and 0 represents that the user is free);

B(t): a vector having size M and representing resource availability at time t. B can be calculate based on the matrix b. For example, Bₖ(t)=Σ_{i∈A(t)}b_{i,k}, where Bₖ indicates an availability (e.g., capacity) of the resource k and A(t)={i∥Sᵢ<t<Sᵢ+pᵢ};

S: a solution vector having a size (N)*1, where an i^{th} component of the solution vector S represents a start date of the i^{th} activity; and

G: optimization criteria (e.g., time duration).

The example solver 230 of FIG. 2 considers the following constraints when performing the optimization:

Time constraints: e.g., if (i, j) ∈ E, than the solution vector S respects the constraint Sⱼ−Sᵢ>pᵢ; and

Resource constraints: Bₖ(t)<1.

The example solver 230 implemented by the optimizer 224 of FIG. 2 can implement partial order planning, or planning that defines action(s) (e.g., task(s)) that should occur before other action(s). In some examples, the solver 230 implements a forward-chaining partial-order planner (POPF planner). The POPF planner employs forward planning such that when a task is scheduled and a resource is allocated to the task, the POPF planner analyzes remaining possible reservations of other tasks that require the same resources and removes the conflicting reservations.

The example optimizer 224 of FIG. 2 uses one or more of the foregoing definitions, time constraints, resource constraints, data inputs, etc. to solve the optimization and determine the workflow(s) 140. The example workflow(s) 140 generated by the optimizer 224 for the user(s) 118, 120, 122 and/or the well testing device(s) 108 include the times at which each user and/or well testing device is to perform a task (e.g., a manual task to be performed by the user, an automated task to be performed by the well testing device). Thus, the workflow(s) 140 provide a time schedule for each user and/or well testing device that includes the task(s) to be performed over the well testing time period, the order in which each task is to be performed, and the time at which each task is to begin. In some examples, the workflow(s) 140 are stored in the database 200 of FIG. 2.

The example job planner 124 of FIG. 2 includes a support availability calculator 232. As disclosed herein, unplanned event(s) can occur during well testing that can result in additional tasks to be performed during the well testing time period. For example, poor sample quality can require more sample measurements to be collected than originally expected. The example support availability calculator 232 determines an availability of one or more users to perform an additional task at any given time based on the workflow(s) 140 generated by the optimizer 224. Put another way, the support availability calculator 232 determines when each user is available (e.g., free) to perform any additional tasks that may arise during well testing. In some examples, the additional task includes providing support to another user performing a planned task. In some examples, the additional tasks are new tasks (e.g., tasks that were not included in the initial task data 202 provided by the user).

Based on the workflow(s) 140 generated by the optimizer 224, the example support availability calculator 232 of FIG. 2 generates support availability data 234 including one or more user availability metrics. In some examples, the support availability calculator 232 calculates a total number of users performing a task at a given time. In some examples, the support availability calculator 232 determines the number of users available to perform additional tasks at a given time. In some examples, the support availability calculator 232 determines a percentage of time that at least one user is available to perform additional task(s). In some examples, the support availability calculator 232 determines whether or not a user is available at a given time based on, for example, a type of task the user is assigned (e.g., whether the user could leave the task to provide support and resume the task at a later time), the qualification level and/or training level of the user (e.g., relative to other users who may be available to provide support), a location of the user at the wellsite 102 and the accessibility of the user to particular well testing device(s) 108 , etc.

In some examples, the example support availability calculator 232 analyzes the support availability data 234 to evaluate the workflow(s) 140 generated by the optimizer 224. For example, if the support availability calculator 232 determines that an average percentage of users available to provide support over the well testing time period is close to zero, then the support availability calculator 232 determines that implementing the workflow(s) 140 may incur the risk that user(s) will not be able to respond quickly to unplanned events during the well testing. As another example, if the support availability calculator 232 determines that an average percentage of users available to provide support over the well testing time period exceeds a threshold (e.g., a predefined threshold), then the support availability calculator 232 determines that well test may be overstaffed with users to perform the tasks. The support availability calculator 232 can analyze the support availability data 234 relative to availability thresholds defined by, for example, the client data 208, industry standards, etc.

In some examples, the support availability calculator 232 provides feedback to the optimizer 224 based on the analysis of the support availability data 234. Based on the support availability data 234, the optimizer 224 can selectively adjust the workflow(s) 140 to account for understaffing or overstaffing and to optimize the availability of user(s) to perform additional task(s) during the well testing in view of the resource and/or time constraints. For example, the optimizer 224 can generate and/or modify the workflow(s) 140 to provide for a threshold number of users (e.g., at least one user) to be available to perform additional task(s) during the well testing time period. In some such examples, if the optimizer 224 is not able to generate workflow(s) 140 in which at least one user is available for support over the well testing time period, the optimizer 224 instructs the communicator 216 to transmit an alert 214 to the user device (e.g., the user device 126 of FIG. 1) informing the user that the crew may be understaffed.

In the example of FIG. 2, the example communicator 216 transmits the workflow(s) 140 to the job scheduler 138 of FIG. 1. In some examples, the communicator 216 transmits the support availability data 234 generated by the support availability calculator 232 to the job scheduler 138. In some examples, the communicator 216 transmits one or more of the task data 202, the crew data 204, the well data 206, and/or the client data 208 to the job scheduler 138. The communicator 216 can transmit the workflow(s) 140 and/or the data 202, 204, 206, 208, 226 to the job scheduler 138 using any past, present, or future communication protocol. In examples where the job planner 124 and the job scheduler 138 are implemented by the same processor, the communicator 216 may send a message to the job scheduler 138 to retrieve the workflow(s) and/or data from, for example, the database 200 of FIG. 2.

While an example manner of implementing the example job planner 124 is illustrated in FIG. 2, one or more of the elements, processes and/or devices illustrated in FIG. 2 may be combined, divided, re-arranged, omitted, eliminated and/or implemented in any other way. Further, the example database 200, the example data analyzer 210, the example communicator 216, the example task allocator 218, the example optimizer 224, the example support availability calculator 223, and/or, more generally, the example job planner 124 of FIG. 2 may be implemented by hardware, software, firmware and/or any combination of hardware, software and/or firmware. Thus, for example, any of the example database 200, the example data analyzer 210, the example communicator 216, the example task allocator 218, the example optimizer 224, the example support availability calculator 223, and/or, more generally, the example job planner 124 of FIG. 2 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example database 200, the example data analyzer 210, the example communicator 216, the example task allocator 218, the example optimizer 224, the example support availability calculator 223, and/or, more generally, the example job planner 124 of FIG. 2 is/are hereby expressly defined to include a non-transitory computer readable storage device or storage disk such as a memory, a digital versatile disk (DVD), a compact disk (CD), a Blu-ray disk, etc. including the software and/or firmware. Further still, the example job planner 124 may include one or more elements, processes and/or devices in addition to, or instead of, those illustrated in FIG. 2, and/or may include more than one of any or all of the illustrated elements, processes and devices.

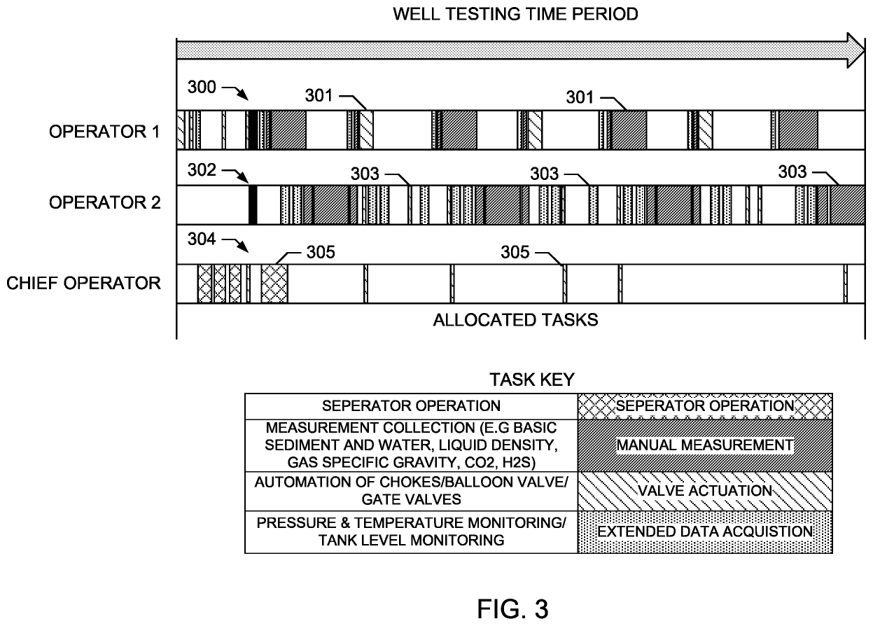

FIG. 3 is a diagram illustrating example task scenarios generated by the example task allocator 218 of FIG. 2 (e.g., the task scenarios 220 of FIG. 2) based on one or more of the task data 202, the crew data 204, the well data 206, and/or the client data 208 received by the example job planner 124 of FIGS. 1 and/or 2. In the example of FIG. 3, the task scenarios include one or more tasks to be performed over a predefined well testing time period (e.g., 4 hours) by operator(s) (e.g., the user(s) 118, 120, 122 of FIG. 1). The example tasks can include, for example, measurement collection; monitoring of parameters such as pressure, temperature, tank level; valve control; and/or other types of tasks (e.g., based on the task data 202). In other examples, the task scenarios of FIG. 3 correspond to task scenarios generated for the well testing device(s) (e.g., the well testing device(s) 108 of FIG. 1).

FIG. 3 includes a first example task scenario 300 including a plurality of tasks 301 to be performed by the first user 118 of FIG. 1 (e.g., a first operator). In some examples, the first user 118 performs tasks to manage the choke manifold(s) 110 of FIG. 1 and to perform measurements (e.g., manual measurements) for the flow such as basic sediment and water content, CO₂, etc. FIG. 3 includes a second example task scenario 302 including a plurality of tasks 303 to be performed by the second user 120 of FIG. 1 (e.g., a second operator). In some examples, the second user 120 performs tasks related to the tank(s) 114 and/or the burner(s) 116 of FIG. 1, including, for example, monitoring level(s) of the tank(s) 114. In some examples, the second user 120 assists the first operator with management of the choke manifold(s) 110. FIG. 3 includes a third example scenario 304 including a plurality of tasks 305 to be performed by the third user 122 of FIG. 1 (e.g., a chief operator). In some examples, the third user 122 manages the separator(s) 112, including for example, setting the pressure and/or temperature levels of the separator(s) 112. In some examples, the third user 122 supervises the first and second users 118, 120.

As illustrated in FIG. 3, each of the users 118, 120, 122 is scheduled to perform respective tasks 301, 303, 305 at different times over the well testing time period, at overlapping times, etc. In some examples, one or more of the users 118, 120, 122 are not performing any tasks at a particular time. The example task allocator 218 can allocate the tasks to the respective users 118, 120, 122 based on, for example, qualification levels of the users as defined in the crew data 204. The example task allocator 218 of FIG. 2 can generate two or more task scenarios for each user 118, 120, 122 that represents different combinations of tasks that can be assigned to each user, different sequences in which the tasks can be performed, different times at which the tasks can be performed, etc.

As disclosed herein, the example optimizer 224 of FIG. 2 analyzes the task scenarios (e.g., the task scenarios 222, 300, 302, 304 of FIGS. 2 and 3) generated by the task allocator 218. The example optimizer 224 implements one or more optimization rule(s) 228 (e.g., job shop optimization algorithms) to generate workflow(s) 140 that enable the user(s) and/or the well testing device(s) to perform the well testing tasks during the well testing time period. As disclosed herein, in some examples, the workflow(s) 140 generated by the optimizer 224 include margins to accommodate unplanned events that may require the user(s) and/or well testing device(s) to perform additional tasks.

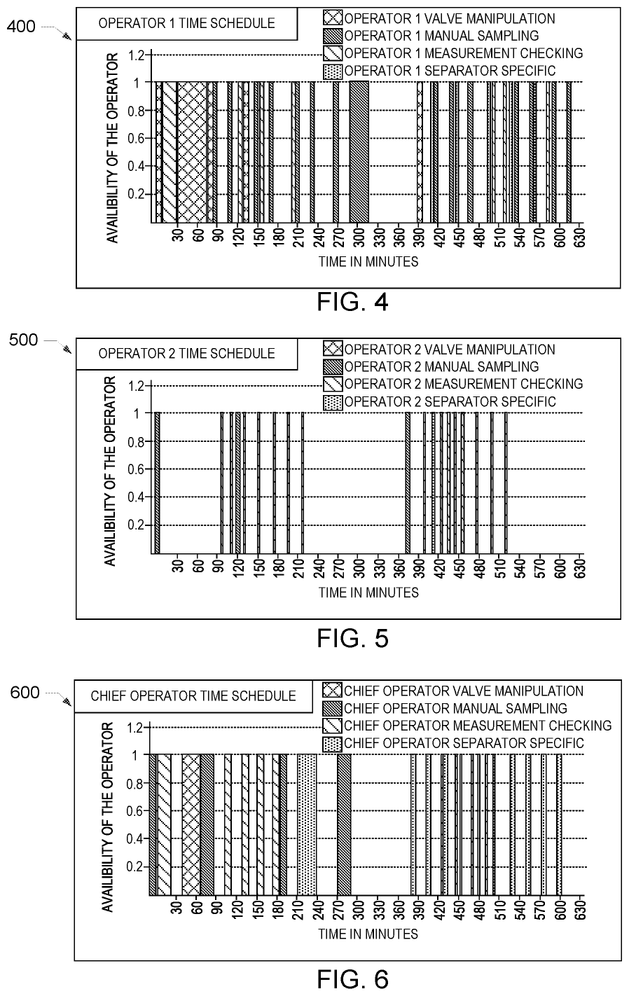

FIGS. 4-6 are graphs illustrating example workflow(s) generated by the example optimizer 224 for the users 118, 120, 122 of FIG. 1. For example, FIG. 4 illustrates an example workflow 400 for the first user 118. FIG. 5 illustrates an example workflow 500 for the second user 120. FIG. 6 illustrates an example workflow 600 for the third user 122. The example workflows 400, 500, 600 of FIGS. 4-6 include time schedules for the respective users that indicate a task that the user is to perform at a given time in the well testing time period (e.g., a well testing time period of 630 minutes), a sequence in which the tasks are to be performed, etc.

The example workflows 400, 500, 600 of FIGS. 4-6 also indicate whether a user is available at a particular time (e.g., assigned a value of 0 in the workflows) or not available (e.g., assigned a value of 1 in the workflows). As disclosed herein, the example support availability calculator 232 determines an availability of one or more users to provide support, perform additional tasks, etc. during the well testing period based on the workflow(s) generated by the example optimizer 224 of FIG. 2.

For example, referring to FIGS. 4-6, the support availability calculator weighs the availability of the first user 118 relative to the second user 120 based on a comparison of the workflow 400 of FIG. 4 for the first user 118 and the workflow 500 of FIG. 5 for the second user 120, the specific tasks assigned to the users 118, 120, the respective training levels of the users 118, 120, etc. For example, for a first given time, the support availability calculator 232 may determine that the second user 120 is available to perform an additional task because the second user 120 is waiting for the first user 118 to complete an allocated task (e.g., valve manipulation). As another example, for a second given time, the support availability calculator 232 may determine that the first user 118 is available to perform an additional task (even if the first user 118 is allocated a task at the second time) to avoid taking the second user away from a task that should not be disrupted (e.g., measurement collection) and/or a task that would interrupt the rest of the workflow if the second user was removed from the task to perform another task (e.g., operating the burner(s) 110).

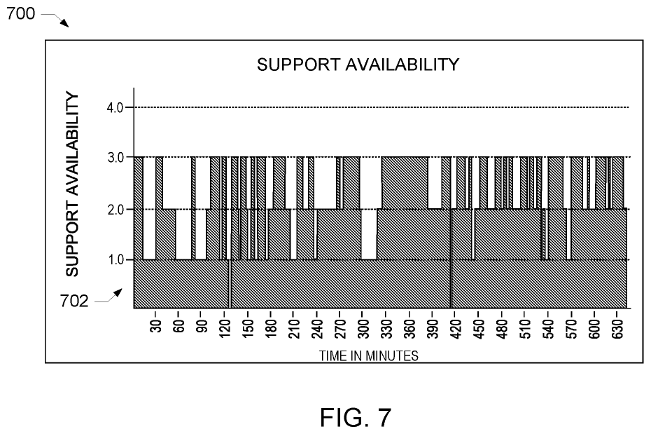

FIG. 7 is a graph illustrating example support availability data 700 generated by the example support availability calculator 232 of FIG. 2. The support availability data 700 of FIG. 7 can be based on the workflow(s) 400, 500, 600 generated by the example optimizer 224 illustrated in FIGS. 4-6. As illustrated in FIG. 7, the example support availability data 700 includes an availability scale 702 indicating an availability of the user(s) (e.g., the users 118, 120, 122) to perform additional tasks over the well testing time period (e.g., a well testing time period having a duration of 630 minutes). In the example of FIG. 7, a value of 3 on the availability scale 702 indicates that all the users are available at a given time. A value of 0 on the availability scale 702 indicates that none of the users are available at a given time. Values between 0 and 3 on the availability scale 702 indicate that some, but not all, of the users are available to perform additional task(s) based on, for example, an ability of user to switch to a different task, a training level of the user, etc. As disclosed herein, in some examples, the optimizer 224 uses the support availability data to generate and/or modify the workflow(s) for one or more users to include availability margins in the workflow(s) to accommodate unplanned events.

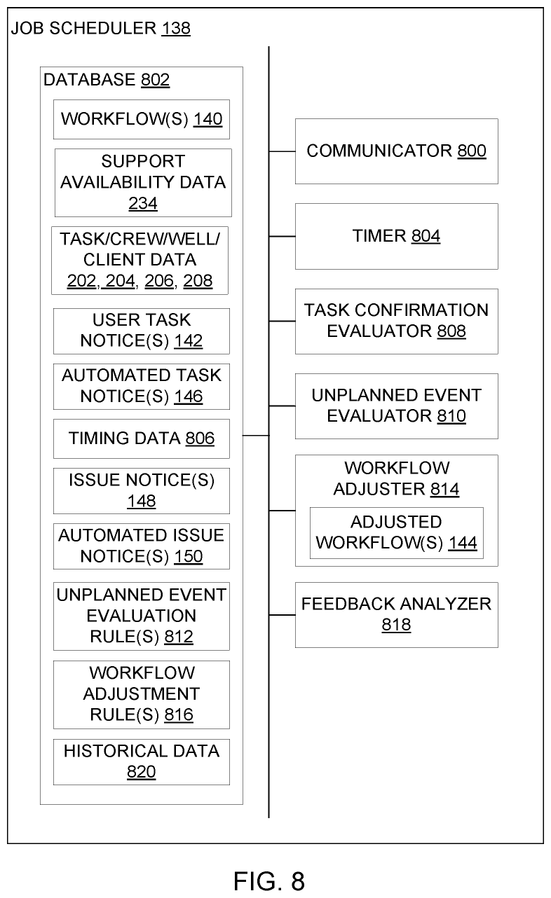

FIG. 8 is a block diagram of an example implementation of the job scheduler 138 of FIG. 1. As mentioned above, the job scheduler 138 is constructed to monitor the execution of workflows generated by the job planner 124 (e.g., the workflow(s) 140, 400, 500, 600) in substantially real-time during the well test and to selectively adjust the workflow(s) based on the monitoring. In the example of FIG. 8, the job scheduler 138 is implemented by a processor (e.g., a processor of a user device, one or more cloud-based devices, etc.). In some examples, the job planner 124 and the job scheduler 138 are implemented by the same processor. In some examples, one or more components of the job planner 124 and/or one or more components of the job scheduler 138 are implemented by two or more processors.

The example job scheduler 138 includes a communicator 800. As disclosed herein, the communicator 216 of the example job planner 124 of FIGS. 1 and/or 2 transmits the workflow(s) 140 to the job scheduler 138. In some examples, the communicator 216 of the job planner 124 transmits the support availability data 234 to the job scheduler 138. In some examples, the communicator 216 of the job planner 124 transmits one or more of the task data 202, the crew data 204, the well data 206, and/or the client data 208 to the job scheduler 138. The communicator 800 of the job scheduler 138 receives the workflow(s) 140 and the data 202, 204, 206, 208, 234 from the example job planner 124.

The example job scheduler 138 includes a database 802. In other examples, the database 802 is located external to the job scheduler 138 in a location accessible to the job scheduler 138. The example database 802 of FIG. 2 stores the workflow(s) 140, the data 202, 204, 206, 208, 234 received from the job planner 124.

The example communicator 800 of FIG. 8 transmits the workflow(s) 140 to one or more user devices for presentation, such as the user device 126 of FIG. 1. The communicator 800 can transmit the workflow(s) 140 to the user device(s) using any other past, present, or future communication protocol (e.g., WiFi, Bluetooth). For example, the communicator 800 can transmit the workflow(s) 140 to respective user devices associated with each user assigned a workflow. In some examples, the communicator 800 transmits the workflows 140 (e.g., all of the workflows) to a user device associated with a supervisor (e.g., the third user 122). In some examples, the communicator 800 transmits the workflow(s) 140 to the user device(s) after receiving an input from the user application 130 (e.g., a user task notice) that the well testing is starting and/or has started.

In some examples, the communicator 800 transmits portion(s) of the workflow(s) 140 to the user device(s) for display. For example, the communicator 800 can transmit a first portion of a workflow 140 including a first task to be performed (e.g., at a current time, an upcoming time, etc.). In some examples, the communicator 800 transmits a second portion of the workflow 140 including a second task to the user device after receiving a user task notice 142 indicating that the first task has been completed. In other examples, the communicator 800 transmits all or substantially all of the workflow(s) 140 including the task(s) to be performed by a user during the well testing time period to the user device at once. In some examples, the user application 130 controls the display of one or more portions of the workflow(s) 140 at the user device(s).

In examples where the workflow(s) 140 include automated task(s) to be performed by the well testing device(s) 108, the communicator 800 transmits the workflow(s) 140 to the well testing device(s) 108. The communicator 800 can transmit a portion of a workflow (e.g., based on receiving the automated task notice(s) 146) and/or substantially all of a workflow including task(s) to be performed by a respective well testing device 108 during the well test.

During performance of the well test, the user(s) perform the task(s) as set forth in the corresponding workflow(s) 140 generated for the user(s). In the example of FIG. 8, when a user completes a task, the user (or a supervisor) provides a user task notice 142 via the user device (e.g., via the user application 130 of the user device 126). The user task notice(s) 142 are stored in the database 802 of FIG. 8. In examples where the well testing device(s) 108 perform automated task(s) as set forth in the respective workflow(s) 140, the well testing device(s) 108 transmit the automated task notice(s) 146 to the job scheduler 138. The automated task notice(s) 146 include confirmation(s) that the automated task(s) were completed by the well testing device(s) 108 assigned the task(s). The automated task notice(s) 146 are stored in the database 802 of FIG. 8.

The example job scheduler 138 includes a timer 804 to record a time at which the user task notice(s) 142 and/or the automated task notice(s) 146 are received by the communicator 800. The timer 804 generates timing data 806 based on the user task notice(s) 142 and/or the automated task notice(s) 146. The timing data 806 includes a time at which each task was completed based on receipt of the task notice(s) 142, 146. In some examples, the timing data 806 includes a start time for a task based on, for example, a time the task is to be performed as set forth in the workflow 140 or a time at which the communicator 800 transmitted the workflow 140 and/or respective portion(s) thereof to the user device(s) and/or the well testing device(s) 108.

The example job scheduler 138 includes a task confirmation evaluator 808. The example task confirmation evaluator 808 analyzes the timing data 806 and determines whether a task in a respective workflow 140 for a user and/or well testing device took less time than allotted for in the workflow 140 by the optimizer 224 of the job planner 124, the expected time, or more time than allotted for in the workflow 140. Based on the analysis of the timing data 806, the task confirmation evaluator 808 determines whether one or more of the workflow(s) 140 for the user(s) and/or the well testing device(s) 108 should be adjusted.

As an example, based on the timing data 806, the task confirmation evaluator 808 determines that the first user 118 took longer to complete a first task than planned for in the workflow 140 generated by the job planner 124 for the first user 118. The task confirmation evaluator 808 determines that the second task to be performed by the first user 118 will begin at a later time than planned in the workflow. As a result, the task confirmation evaluator 808 determines that the first user 118 will not have time to complete his or her remaining tasks in the workflow 140 due to the delay in starting the second task. Accordingly, the task confirmation evaluator 808 determines that the workflow 140 for the first user 118 should be adjusted.

As another example, based on the timing data 806, the task confirmation evaluator 808 determines that the first user 118 completed the first task in less time that planned for in the workflow 140. Accordingly, the task confirmation evaluator 808 determines that the workflow 140 for the first user 118 should be adjusted to increase a number of tasks performed by the first user 118, to reevaluate an availability of the first user 118 to provide support, etc.

The example job scheduler 138 of FIG. 8 includes an unplanned event evaluator 810. As disclosed above, during the well test, one or more unplanned events may occur, such as a leak, surge flow conditions, change in wind direction, poor sample quality, etc. In some examples, the unplanned event(s) are mitigated by the performance of one or more tasks, such as stopping the leak, collecting additional samples, obtaining measurements from the additional samples, etc. In the example of FIG. 8, when unplanned event(s) occur, the user(s) provide one or more issue notice(s) 148 to the job scheduler 138 via the user application 130. The issue notice(s) 148 indicate which unplanned event(s) have occurred (e.g., based on predefined input(s)). In some examples, the timer 804 records the time at which the issue notice(s) 148 were received. In other examples, the issue notice(s) 148 include the time(s) of the unplanned event(s). The issue notice(s) 148 and associated timing data are stored in the database 802.

In examples where the well testing device(s) 108 perform automated task(s), the well testing device(s) 108 can include sensor(s) to detect if an unplanned event has occurred (e.g., a valve has not fully closed). In examples where the sensor(s) detect unplanned event(s) at the well testing device(s) 108, the processor(s) associated with the well testing device(s) 108 transmit automated issue notice(s) 150 to the job scheduler 138. In some examples, the timer 804 records the time at which the automated issue notice(s) 150 were received. In other examples, the automated issue notice(s) 150 include the time(s) of the unplanned event(s). The automated issue notice(s) 150 and associated timing data are stored in the database 802.

The example unplanned event evaluator 810 of FIG. 8 analyzes the issue notice(s) 148 and/or the automated issue notice(s) 150 and determines whether the workflow(s) 140 should be adjusted due to the unplanned events. The example unplanned event evaluator 808 applies one or more unplanned event evaluation rules 812 to determine if the workflow(s) 140 should be adjusted. The unplanned event evaluation rule(s) 812 can be defined by user input(s) and/or historical data. In some examples, the unplanned event rule(s) 812 include a listing of particular (e.g., predefined) unplanned event(s) and indications as to whether the unplanned event(s) require additional task(s) to be performed to mitigate the unplanned event(s). The example unplanned event evaluator 810 analyzes the issue notice(s) 148, 150 based on the rule(s) 812 to determine if the unplanned event(s) associated with the issue notice(s) 148, 150 are event(s) that require mitigation task(s) to be performed. If the example unplanned event evaluator 810 determines that mitigation task(s) are to be performed, the unplanned event evaluator 810 determines that one or more of the workflows 140 should be adjusted.

The example job scheduler 138 includes a workflow adjuster 814. The example workflow adjuster 814 provides means for adjusting the workflow(s) 140 in substantially real-time during the well test to generate the adjusted workflow(s) 144. In the example of FIG. 8, if the task confirmation evaluator 808 determines that one or more workflow(s) 140 should be adjusted due to delays in the performance of the task(s), the task confirmation evaluator 808 transmits one or more messages to the workflow adjuster 814. Also, in the example of FIG. 8, if the example unplanned event evaluator 810 determines that the workflow(s) 140 should be adjusted due to one or more unplanned events that require mitigation tasks to be performed, the unplanned event evaluator 810 transmits one or more messages to the workflow adjuster 814.

In response to receiving message(s) from the task confirmation evaluator 808 and/or the unplanned event evaluator 810, the example workflow adjuster 814 analyzes the workflow(s) 140. In some examples, the workflow adjuster 814 analyzes the workflow(s) 140 for all or substantially all of the user(s) and/or well testing device(s) 108. In other examples, the workflow adjuster 814 analyzes one or more of the workflow(s) 140 based on, for example, the user and/or well testing device associated with the delay in the task performance, the type of unplanned event, the number of mitigation tasks to be performed, etc.

The example workflow adjuster 814 of FIG. 8 applies one or more workflow adjustment rules 816 to adjust the workflow(s) 140. The example adjustment rule(s) 816 can be defined by one or more user inputs and/or based on historical data. The example adjustment rule(s) 816 include instructions as to how the workflow adjuster 814 should adjust the workflow(s) 140 based on the reason(s) for the adjustment(s) (e.g., task completion delay(s) and/or unplanned event(s)), the task(s) that have been performed and/or are to be performed during the well testing time period, the support availability data 234, the well data 206 (e.g., conditions at the well 104, specifications for the well testing device(s) 108), etc. In some examples, the adjustment rule(s) 816 include instruction(s) for adjusting the workflow(s) 140 based on the crew data 204 (e.g., training and/or qualification levels of the user(s)) and/or other data (e.g., client data 208).

In some examples, the adjustment rule(s) 816 include decision trees that instruct the workflow adjuster 814 as to how to adjust the workflow(s) 140 when, for example, a particular task is delayed, or a particular unplanned event occurs. For example, the adjustment rule(s) 816 can indicate that when a choke is plugged with a hydrate, a glycol injection pump should be activated. As another example the adjustment rule(s) 816 can indicate that if a first task is delayed, the first task should be replaced with a second task. Thus, in some examples, the workflow adjuster 814 determines the adjustment(s) that should be made to the workflow(s) based on mapping(s) between the unplanned event(s) and/or task delay(s) and predefined response(s) as set forth in the workflow adjustment rule(s) 816. In some examples, the workflow adjustment rule(s) 816 include optimization algorithms to be implemented by the workflow adjuster 814.

The example workflow adjuster 814 adjusts the workflow(s) 140 based on the workflow adjustment rule(s) 816, the well testing time constraints, and/or the resource constraints. For example, in view of time constraints for completing the well test, the workflow adjuster 814 may revise a workflow 140 including a delay in task performance by removing a task from the workflow 140, revising the workflow so that a later-scheduled task is performed sooner than originally planned, etc. In some examples, the workflow adjuster 814 shifts one or more tasks between two or more workflows 140 to compensate for the task delay and to enable the tasks to be completed within the well testing time period. In some such examples, the workflow adjuster 814 evaluates, for example, the support availability data 234 indicating that one or more other users are available to perform tasks and/or the crew data 204 (e.g., the user training levels) before shifting the task(s) between workflows.

In some examples, the workflow adjuster 814 adds one or more tasks to one or more workflows for the user(s) and/or the well testing device(s) in response to, for example, an unplanned event. In determining to which workflow(s) 140 the additional (e.g., mitigation) task(s) are to be added, the workflow adjuster 814 considers, for example, the support availability data 234, the crew data 204 (e.g., user qualification levels, locations of the user(s) at a given time), the other task(s) in the workflow(s), the remaining time in the well testing time period, etc. In some examples, if the availability of the user(s) is limited, the workflow adjuster 814 determines if another task can be removed from a workflow based on, for example, a priority of the mitigation task(s) to address the unplanned event over the other (e.g., planned) tasks. Thus, in some examples, the workflow adjuster 814 prioritizes the tasks to determine the adjustments.

In some examples, the workflow adjuster 814 generates two or more workflow adjustment scenarios and weighs the adjustments in each scenario to determine how to adjust the workflow(s) 140. For example, based on time and/or resource constraints, the example workflow adjuster 814 may weigh removing a task from a workflow as set for in a first workflow adjustment scenario against shifting the task to be performed at a later time in the workflow as set forth in a second workflow adjustment scenario. The workflow adjuster 814 may weigh the workflow adjustment scenarios based on, for example, priority of the task(s), the effect of shifting the task to a later time on the support availability of the user associated with the workflow, etc.

In some examples, the workflow adjuster 814 adjusts the workflow(s) based on user input(s) received in substantially real-time via the user application 130. For example, the third user 122 can indicate an adjustment to be made in response to an unplanned event based on user preference. The user-defined adjustment can be provided with, for example, the issue notice(s) 148. In such examples, the workflow adjuster 814 implements the user-defined adjustment (e.g., as long as time and/or resource constraints are satisfied).

Based on the adjustment(s), the example workflow adjuster 814 generates the adjusted workflow(s) 144 for the user(s) and/or the well testing device(s) 108. The example communicator 800 transmits the adjusted workflow(s) 144 to the user device(s) (e.g., the user device 126) and/or the well testing device(s) 108 (e.g., via WiFi, Bluetooth). Thus, the user(s) and/or well testing device(s) 108 receive the adjusted workflow(s) 144 generated by the workflow adjuster 814 in substantially real-time based on the notice(s) 142, 146, 148, 150 received by the job scheduler 138 during the well test. The example workflow adjuster 814 continues adjusting the workflow(s) and generating the adjusted workflow(s) 144 during the well testing time period based on the notice(s) 142, 146, 148, 150. Thus, in some examples, the workflow adjuster 814 revises the workflow(s) multiple times over the well testing time period.

The example job scheduler 138 includes a feedback analyzer 818. The example feedback analyzer 818 generates historical data 820 over one or more well testing time periods, including, for example, the types of unplanned events and/or delays that occurred during the well testing time period(s), the adjustment(s) made by the workflow adjuster 814 to the workflow(s), any user input(s) received indicating preferred adjustment(s) to be made, average time for completing the task(s) based on the timing data 806, etc. The example feedback analyzer 818 analyzes the historical data 820 to determine if the workflow adjustment rule(s) 816 should be updated based on, for example, changes, trends, patterns, etc. in the historical data 820 generated for one or more well testing time periods. For example, the feedback analyzer 818 identifies that the addition of a particular task to a workflow caused delays in completing the other task(s) in the workflow. In such examples, the feedback analyzer 818 updates the workflow adjustment rule(s) 816 to indicate that if the particular task is to be added to the workflow, then another task should be removed from the workflow and/or shifted to another user's workflow to reduce the likelihood of introducing delays. The workflow adjuster 214 applies the updated workflow adjustment rule(s) to adjust other workflows. Thus, the example job scheduler 138 provides for self-learning based on the workflow adjustments.

In some examples, the example feedback analyzer 818 of FIG. 8 communicates with the optimizer 224 of the job planner 124 of FIG. 2 (e.g., via the communicators 216, 800 of FIGS. 2 and 8) to adjust the optimization rule(s) 228 based on the historical data 820. For example, in view of repeated delays in the completion of a task, the feedback analyzer 818 may instruct the optimizer 224 to allocate more time for completion of the task in the workflow(s) 140 generated by the optimizer 224. As another example, based on the historical data 820, the feedback analyzer 818 may instruct the optimizer 224 to provide for increased user support availability to reduce instances in which support availability is limited. Thus, in some examples, the feedback analyzer 818 seeks to reduce instances in which the workflow adjuster 814 generates the adjusted workflow(s) 144 to improve efficiency of the creation of workflows by optimizer 224 and, thus, the well testing operations.

While an example manner of implementing the example job scheduler 138 is illustrated in FIG. 8, one or more of the elements, processes and/or devices illustrated in FIG. 8may be combined, divided, re-arranged, omitted, eliminated and/or implemented in any other way. Further, the example communicator 800, the database 802, the example database 802, the example timer 804, the example task confirmation evaluator 808, the example unplanned event evaluator 810, the example workflow adjuster 814, the example feedback analyzer 818, and/or, more generally, the example job scheduler 138 of FIG. 8 may be implemented by hardware, software, firmware and/or any combination of hardware, software and/or firmware. Thus, for example, any of the example communicator 800, the database 802, the example database 802, the example timer 804, the example task confirmation evaluator 808, the example unplanned event evaluator 810, the example workflow adjuster 814, the example feedback analyzer 818, and/or, more generally, the example job scheduler 138 of FIG. 8 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example communicator 800, the database 802, the example database 802, the example timer 804, the example task confirmation evaluator 808, the example unplanned event evaluator 810, the example workflow adjuster 814, the example feedback analyzer 818, and/or, more generally, the example job scheduler 138 of FIG. 8 is/are hereby expressly defined to include a non-transitory computer readable storage device or storage disk such as a memory, a digital versatile disk (DVD), a compact disk (CD), a Blu-ray disk, etc. including the software and/or firmware. Further still, the example job scheduler 138 may include one or more elements, processes and/or devices in addition to, or instead of, those illustrated in FIG. 8, and/or may include more than one of any or all of the illustrated elements, processes and devices.

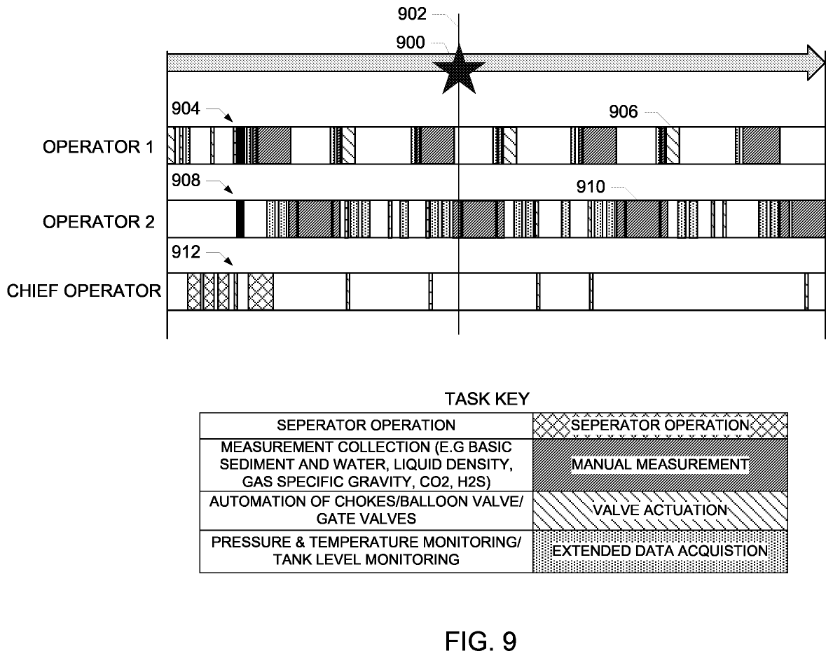

FIG. 9 is a diagram of example workflow adjustment scenarios generated by the example workflow adjuster 814 of FIG. 8 based on the issue notice(s) 148, 150 from received from the user application 130 and/or the well testing device(s) 108. In the example of FIG. 9, the issue notice(s) 148, 150 indicate that an unplanned event 900 has occurred at a first time 902 during the well test. The example workflow adjuster 814 generates a first workflow adjustment scenario 904 for the first user 118 of FIG. 1 by allocating (e.g., adding) a first mitigation task 906 to be performed by the first user (e.g., at a time after the first time 902). In the example of FIG. 9, the first mitigation task 906 was not included in the workflow 140 for the first user 118 generated by the optimizer 224 of the job planner 124. The example workflow adjuster 814 generates a second workflow adjustment scenario 908 for the second user 120 of FIG. 1 by allocating (e.g., adding) a second mitigation task 910 to be performed by the second user 120 (e.g., at a time after the first time 902). In the example of FIG. 9, the second mitigation task 910 was not included in the workflow 140 for the second user 120 generated by the optimizer 224 of the job planner 124. The example workflow adjuster 814 adjusts the workflow(s) for the users 118, 120 to include the mitigation tasks 906. 908 based on, for example, the support availability of the users 118, 120 during the time period after the first time 902 at which the unplanned event 900 occurred, the qualification levels of the users 118, 120, the other tasks to be performed by users 118, 120, etc.

The example diagram of FIG. 9 includes a third workflow adjustment scenario 912 for the third user 122 of FIG. 1 (e.g., the chief operator). In the example of FIG. 9, the workflow adjuster 814 determines that the workflow for the third user 122 should be not adjusted to include a mitigation task to preserve the availability of the third user 122 to oversee operations. In other examples, the workflow adjuster 214 determines that a mitigation task should be allocated to workflow of the third user 122 in addition to or as an alternative to adding mitigation task(s) to the workflows of the first and/or second user(s) 118, 120.

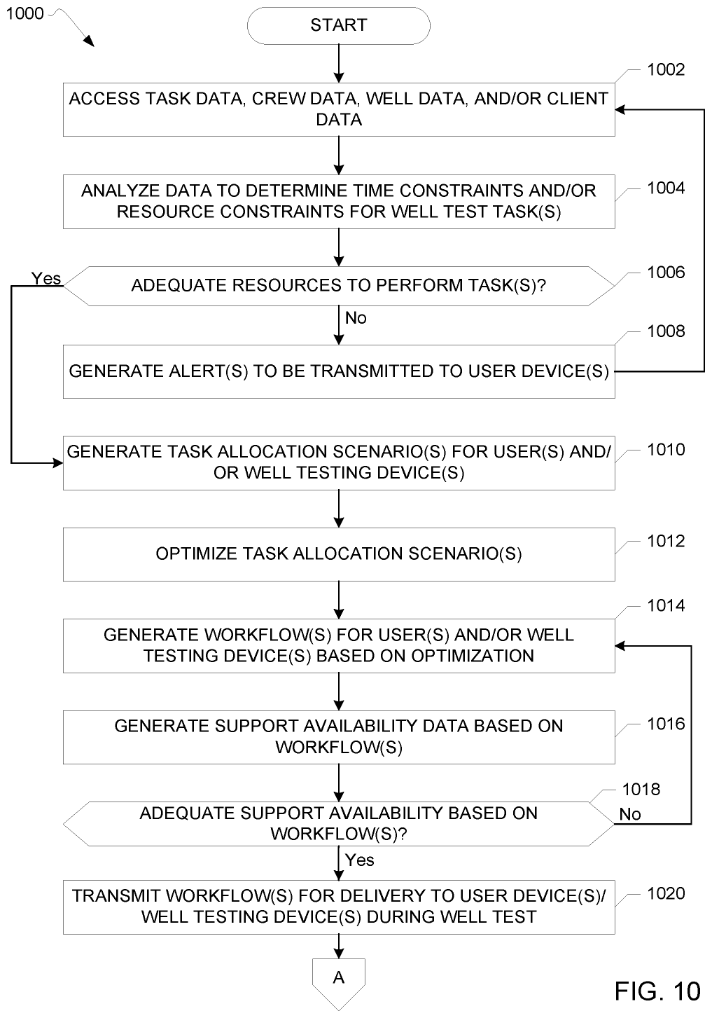

FIG. 10 illustrates a flowchart representative of an example method 1000 that can be implemented to generate workflow(s) for user(s) (e.g., the user(s) 118, 120, 122 of FIG. 1) and/or well testing device(s) (e.g., the well testing device(s) 108 of FIG. 1) including task(s) to be performed during the well test by the user(s) and/or well testing device(s). The method 1000 of FIG. 10 can be implemented by the example job planner 124 of FIGS. 1 and/or 2.

The example method 1000 begins with accessing one or more of task data, crew data, well data, and/or client data (block 1002). For examples, the job planner 124 of FIG. 10 receives the task data 202, the crew data 204, the well data 206, and/or the client data 208 from the user application 130 of the user device 126 of FIG. 1. The data is stored in the database 200 of FIG. 2.

The example method 1000 includes analyzing the data to determine time constraints and/or resource constraints for one or more well test tasks (block 1004). For example, the data analyzer 210 of FIG. 2 analyzes the task data 202, the crew data 204, the well data 206, and/or the client data 208 to determine the task(s) to be performed, the time period over which the task(s) are to be performed, the frequency at which the task(s) are to be performed, the number of users to perform the task(s), the qualification levels of the users, etc.

The example method 1000 includes a determination of whether there are adequate resources to perform the task(s) (block 1006). If a determination is made that there are not adequate resources to perform the task(s), the example method 1000 includes generating alert(s) to be transmitted to the user device(s) (block 1008). For example, if the data analyzer 210 determines that there are not enough users and/or well testing device(s) 108 to perform the tasks based on, for example, time constraints, safety constraints, etc., then the data analyzer 210 instructs the communicator 216 of FIG. 2 to generate alert(s) 214 to be transmitted to the user device(s). In such examples, the example method 1000 continues with accessing data (e.g., revised data including crew data with an increased number of users) to determine if there are adequate resources to perform the tasks.

If there are adequate resources (e.g., users, devices) to perform the task(s), the example method 1000 continues with generating task allocation scenarios (block 1010). For example, the task allocator 218 of FIG. 2 allocates the task(s) to the user(s) and/or well testing device(s) based on the task allocation rule(s) 222, the crew data, the well data, the client data, etc. The task allocator 218 generates the task scenarios 222, 300, 302, 304 based on the task allocation rule(s) 222.

The example method 1000 includes optimizing the task allocation scenario(s) (block 1012). The example method 1000 includes generating workflow(s) for the user(s) and/or the well testing device(s) based on the optimization of the task allocation scenarios (block 1014). For example, the solver 230 of the optimizer 224 applies one or more optimization rule(s) 228 (e.g., algorithms such as job shop optimization algorithms) to determine workflow(s) for the user(s) that satisfy the time and/or resource constraints. The optimizer 224 determines which task scenarios and/or combinations of task scenarios provide for the task(s) to be completed within the well testing time period and provide for availability of users during the well testing period to perform additional tasks due to unplanned event(s). The optimizer 224 generates the workflow(s) 140, 400, 500, 600 based on the application of the optimization rule(s) 228.

The example method 1000 includes generating support availability data based on the workflow(s) (block 1016). For example, the support availability calculator 232 determines an availability of one or more users to perform an additional task (e.g., a mitigation task due to an unplanned event and/or a delay in task completion) at any given time based on the workflow(s) 140, 400, 500, 600 generated by the optimizer 224. The support availability calculator 232 generates support availability data 234 based on the analysis.

The example method 1000 includes a determination of whether there is adequate support availability to respond to, for example, unplanned events and/or task completion delays (block 1018). For example, if the support availability calculator 232 determines, based on the support availability data 234, that no users are available to provide support for a threshold period of time during the well test, then the support availability calculator 232 may determine that the workflow(s) 140, 400, 500, 600 do not provide for adequate support availability. Conversely, the support availability calculator 232 may determine that the workflow(s) 140 provide for too much user availability such that the users are not performing tasks to complete the well test in an efficient manner. If a determination is made that there is not adequate support availability (e.g., too little or too much availability based on availability thresholds), the example method 1000 continues with generating workflow(s) that optimize user availability and efficiency in completing the well test tasks (block 1014).

If a determination is made that there is adequate support availability, the example method 1000 includes transmitting the workflow(s) to the user device(s) (e.g., for presentation to the user(s)) and/or the well testing device(s) (block 1020). For example, the communicator 216 of the job planner 124 transmits the workflow(s) 140, 400, 500, 600 to the job scheduler 138 of FIG. 8 for delivery to the user device(s) 126 and/or the well testing device(s) 108 during the well test.

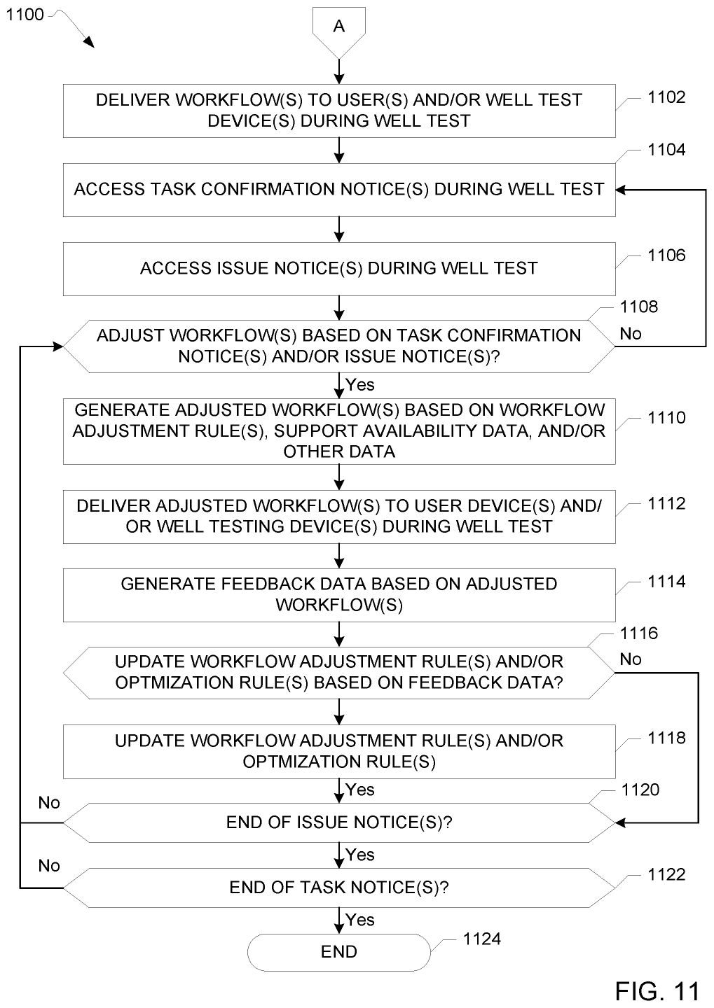

FIG. 11 illustrates a flowchart representative of an example method 1100 that can be implemented to monitor workflow(s) for user(s) (e.g., the user(s) 118, 120, 122 of FIG. 1) and/or well testing device(s) (e.g., the well testing device(s) 108 of FIG. 1) and adjust the workflow(s) in substantially real-time. The method 1100 of FIG. 11 can be implemented by the example job scheduler 138 of FIGS. 1 and/or 8.

The example method 1100 begins with delivering workflow(s) to user(s) (e.g., via the user device 126) and/or well test device(s) during a well test (block 1102). For example, the communicator 800 of FIG. 8 transmits (e.g., wirelessly), the workflow(s) 140, 400, 500, 600 to the user device(s) 126 and/or the well testing device(s) 108 that have been assigned workflow(s).

The example method 1100 includes accessing task confirmation notice(s) during the well test (block 1104). For example, the communicator 800 receives user task notice(s) 142 from the user(s) 118, 120, 122 (e.g., via the user application 130) indicating that one or more manual tasks in the workflow(s) 140, 400, 500, 600 have been completed. In some examples, the communicator 800 receives automated task notice(s) 146 from the well testing device(s) 108 indicating that one or more automated tasks have been completed.

The example method 1100 includes accessing issue notice(s) during the well test (block 1106). For example, the communicator 800 receives issue notice(s) 148 from the user device(s) indicating that one or more unplanned events have occurred during the well test. In some examples, the communicator 800 receives automated issue notice(s) 150 from the well testing device(s) 108 indicating that one or more unplanned event have occurred at the well testing device(s) 108 (e.g., as detected by one or more sensor(s)).

The example method 1100 includes determining whether the workflow(s) should be adjusted based on the task confirmation notice(s) and/or the issue notice(s) (block 1108). For example, the task confirmation evaluator 808 analyzes timing data 806 generated by the timer 804 when the user task notice(s) 142 and/or the automated task notice(s) 146 are received. The task confirmation evaluator 808 determines if there has been delay(s) in the completion of the task(s) in a workflow 140, 400, 500, 600 that could affect the completion of other tasks in the workflow 140, 400, 500, 600. If there have been delay(s), the task confirmation evaluator 808 determines that one or more of the workflows for the well test should be adjusted to compensate for the task delay.

In some examples, the unplanned event evaluator 810 analyzes the issue notice(s) 148, 150 to determine whether the unplanned event(s) require one or more tasks to be performed to mitigate the unplanned event(s) (e.g., based on the unplanned event evaluation rule(s) 812). If the unplanned event evaluator 810 determines that mitigation task(s) are required as a result of the unplanned event(s), the unplanned event evaluator 810 determines that the workflow(s) should be adjusted to accommodate the mitigation task(s).

If the task confirmation evaluator 808 and/or the unplanned event evaluator 810 determine that the workflow(s) do not need to be adjusted, the example method 1100 continues to access the task notice(s) 142, 146 and/or the issue notice(s) 148, 150 to determine notices whether the notice(s) indicate the workflow(s) should be adjusted.

The example method 1100 includes generating adjusted workflow(s) based on workflow adjustment rule(s), support availability data, and/or other data such as the crew data, client data, etc. (block 1110). For example, based on the unplanned event, the workflow adjuster 814 applies one or more workflow adjustment rule(s) 816 (e.g., decision trees) to determine the how to adjust the workflow(s) 140, 400, 500, 600 to generate the adjusted workflow(s) 144. In some examples, the workflow adjuster 814 adjusts the workflow(s) based on the support availability data 234 indicating that one or more users are available to perform task(s) not originally in the workflow(s) 140, 400, 500, 600. In some examples, the workflow adjuster 814 determines the adjustment(s) to the workflow(s) 140, 400, 500, 600 based on the qualification level(s) of the user(s), user inputs regarding preferred adjustments, well conditions, task priority, etc. In some examples, the workflow adjuster 814 generates one or more workflow adjustment scenarios 904, 908, 912 and evaluates (e.g., weighs, optimizes) the scenario(s) the scenarios to generate the adjusted workflow(s) 144.

The example method 1100 includes delivering the adjusted workflow(s) to the user device(s) and/or well testing device(s) during the well test (block 1112). For example, the communicator 800 transmits the adjusted workflow(s) 144 to the user device(s) and/or the well testing device(s) during the well test so as to deliver the adjusted workflow(s) to the user(s) and/or well test device(s) 108 in substantially real-time.

The example method 1100 includes generating feedback data based on the adjusted workflow(s) (block 1114). For example, the feedback analyzer 818 generates historical data 820 based on the adjustment(s) by the workflow adjuster 814 to the workflow(s) 140, 400, 500, 600 for one or more well test time periods.

The example method 1100 includes a determination of whether the workflow adjustment rule(s) and/or optimization rules should be updated based on the feedback data (block 1116). If the rule(s) are to be updated, the example method 1100 includes updating the rule(s) (block 1118). For example, the feedback analyzer 818 analyzes changes, trends, patterns, etc. in the historical data. Based on the analysis, the feedback analyzer 818 determines whether the workflow adjustment rule(s) 816 should be updated, for example, to reduce introducing delays into the workflows by modifying the rule(s) to indicate that a task should be removed from a workflow instead of shifted in the workflow to be performed at a later time. In some examples, the feedback analyzer 818 determines that the workflow adjustment rule(s) 816 should be automatically updated to insert a mitigation task preferred by the user over another mitigation task. In some examples, the feedback analyzer 818 determines that the optimization rules 228 implemented by the optimizer 224 of the job planner 124 of FIG. 2 should be modified to reduce, for example, instances of task completion delays by allocating more time for a task when generating the workflow(s) 140.

The example method 1100 continues to analyze the issue notice(s) and/or the task notice(s) to determine if adjustments should be made to the workflow(s) (block 1120, 1124). The example method 1100 ends when no further issue notice(s) or task notice(s) are received (block 1124).

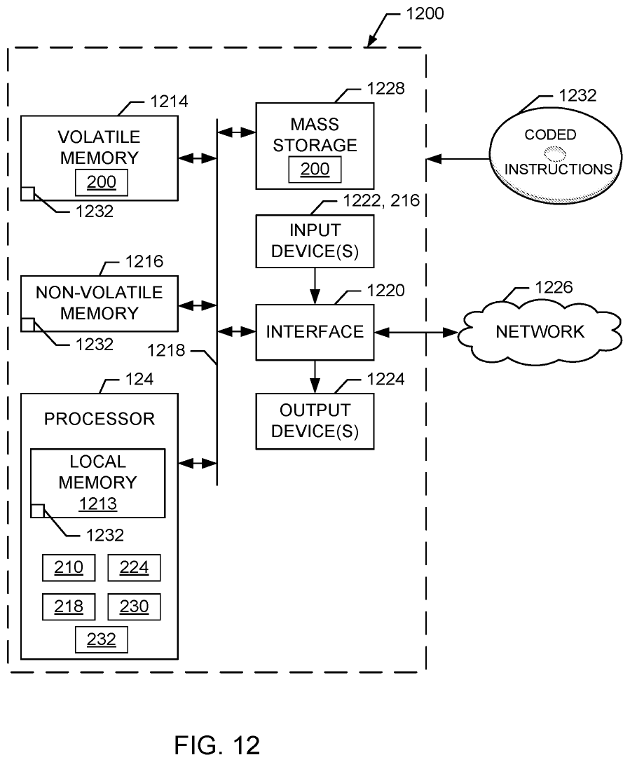

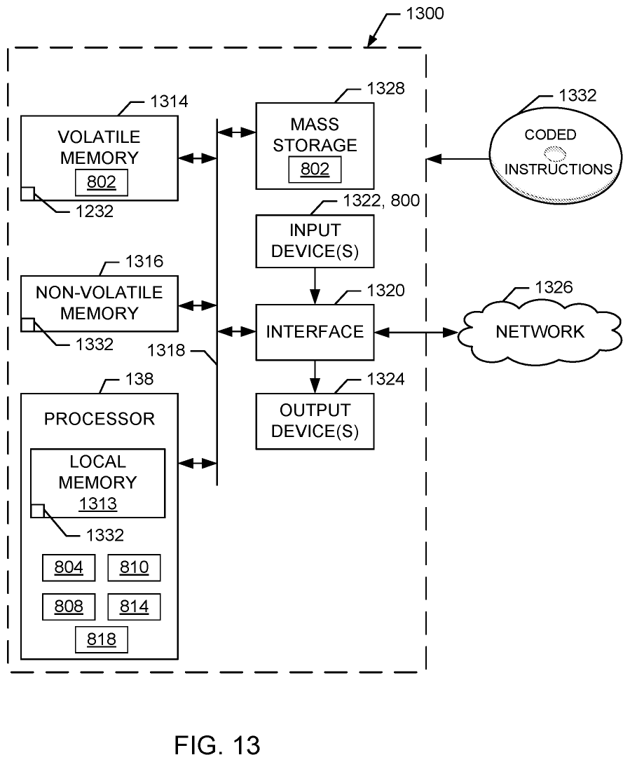

The flowcharts of FIGS. 10 and 11 are representative of example methods that may be used to implement the example job planner 124 and/or the example job scheduler 138 of FIGS. 1, 2, and/or 8. In these examples, the methods may be implemented using machine readable instructions comprising a program for execution by one or more processors such as the processor(s) 124, 138 shown in the example processor platform(s) 1200, 1300 discussed below in connection with FIGS. 12 and 13. The program may be embodied in software stored on a non-transitory computer readable storage medium such as a CD-ROM, a floppy disk, a hard drive, a digital versatile disk (DVD), a Blu-ray disk, or a memory associated with the processor(s) 124, 138, but the entire program and/or parts thereof could alternatively be executed by a device other than the processor(s) 124, 138 and/or embodied in firmware or dedicated hardware. Further, although the example program is described with reference to the flowchart illustrated in FIG. 4, many other methods of implementing the example job planner and/or the example job scheduler may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, a Field Programmable Gate Array (FPGA), an Application Specific Integrated circuit (ASIC), a comparator, an operational-amplifier (op-amp), a logic circuit, etc.) structured to perform the corresponding operation without executing software or firmware.

As mentioned above, the example processes of FIGS.10 and 11 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. “Including” and “comprising” (and all forms and tenses thereof) are used herein to be open ended terms. Thus, whenever a claim lists anything following any form of “include” or “comprise” (e.g., comprises, includes, comprising, including, etc.), it is to be understood that additional elements, terms, etc. may be present without falling outside the scope of the corresponding claim. As used herein, when the phrase “at least” is used as the transition term in a preamble of a claim, it is open-ended in the same manner as the term “comprising” and “including” are open ended.

FIG. 12 is a block diagram of an example processor platform 1200 capable of executing instructions to implement the method of FIG. 10 to implement the job planner of FIGS. 1 and/or 2. The processor platform 1200 can be, for example, a server, a personal computer, a mobile device (e.g., a cell phone, a smart phone, a tablet such as an iPad™), a personal digital assistant (PDA), an Internet appliance, or any other type of computing device.

The processor platform 1200 of the illustrated example includes a processor 124. The processor 124 of the illustrated example is hardware. For example, the processor 124 can be implemented by one or more integrated circuits, logic circuits, microprocessors or controllers from any desired family or manufacturer. The hardware processor may be a semiconductor based (e.g., silicon based) device. In this example, the processor 124 implements the example data analyzer 210, the example task allocator 218, the example optimizer 224, and/or the example support availability calculator 232 of the example job planner.

The processor 124 of the illustrated example includes a local memory 1213 (e.g., a cache). The processor 124 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1216 may be implemented by flash memory and/or any other desired type of memory device. Access to the main memory 1214, 1216 is controlled by a memory controller. The database 200 of the job planner may be implemented by the main memory 1214, 1216 and/or the local memory 1213.

The processor platform 1200 of the illustrated example also includes an interface circuit 1220. The interface circuit 1220 may be implemented by any type of interface standard, such as an Ethernet interface, a universal serial bus (USB), and/or a PCI express interface.

In the illustrated example, one or more input devices 1222 are connected to the interface circuit 1220. The input device(s) 1222 permit(s) a user to enter data and/or commands into the processor 124. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1220 of the illustrated example, thus, typically includes a graphics driver card, a graphics driver chip and/or a graphics driver processor.

The interface circuit 1220 of the illustrated example also includes a communication device such as a transmitter, a receiver, a transceiver, a modem and/or network interface card to facilitate exchange of data with external machines (e.g., computing devices of any kind) via a network 1226 (e.g., an Ethernet connection, a digital subscriber line (DSL), a telephone line, coaxial cable, a cellular telephone system, etc.). In this example, the interface circuit 1220 implements the communicator 216.

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, RAID systems, and digital versatile disk (DVD) drives.

Coded instructions 1232 to implement the method of FIG. 10 may be stored in the mass storage device 1228, in the volatile memory 1214, in the non-volatile memory 1216, and/or on a removable tangible computer readable storage medium such as a CD or DVD.

FIG. 13 is a block diagram of an example processor platform 1300 capable of executing instructions to implement the method of FIG. 11 to implement the job scheduler of FIGS. 1 and/or 8. The processor platform 1300 can be, for example, a server, a personal computer, a mobile device (e.g., a cell phone, a smart phone, a tablet such as an iPad™), a personal digital assistant (PDA), an Internet appliance, or any other type of computing device.

The processor platform 1300 of the illustrated example includes a processor 138. The processor 138 of the illustrated example is hardware. For example, the processor 138 can be implemented by one or more integrated circuits, logic circuits, microprocessors or controllers from any desired family or manufacturer. The hardware processor may be a semiconductor based (e.g., silicon based) device. In this example, the processor 138 implements the example timer 804, the example task confirmation evaluator 808, the example unplanned event evaluator 810, the example workflow adjuster 814, and/or the example feedback analyzer 818 of the example job planner.

The processor 138 of the illustrated example includes a local memory 1313 (e.g., a cache). The processor 138 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1316 may be implemented by flash memory and/or any other desired type of memory device. Access to the main memory 1314, 1316 is controlled by a memory controller. The database 802 of the job scheduler may be implemented by the main memory 1314, 1316 and/or the local memory 1313.

The processor platform 1300 of the illustrated example also includes an interface circuit 1320. The interface circuit 1320 may be implemented by any type of interface standard, such as an Ethernet interface, a universal serial bus (USB), and/or a PCI express interface.

In the illustrated example, one or more input devices 1322 are connected to the interface circuit 1320. The input device(s) 1322 permit(s) a user to enter data and/or commands into the processor 138. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1320 of the illustrated example, thus, typically includes a graphics driver card, a graphics driver chip and/or a graphics driver processor.

The interface circuit 1320 of the illustrated example also includes a communication device such as a transmitter, a receiver, a transceiver, a modem and/or network interface card to facilitate exchange of data with external machines (e.g., computing devices of any kind) via a network 1326 (e.g., an Ethernet connection, a digital subscriber line (DSL), a telephone line, coaxial cable, a cellular telephone system, etc.). In this example, the interface circuit 1320 implements the communicator 800.

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, RAID systems, and digital versatile disk (DVD) drives.

Coded instructions 1332 to implement the method of FIG. 11 may be stored in the mass storage device 1328, in the volatile memory 1314, in the non-volatile memory 1316, and/or on a removable tangible computer readable storage medium such as a CD or DVD.

From the foregoing, it will be appreciated that above-disclosed apparatus, systems and methods provide for automatic generation of workflows including tasks to be implemented by user(s) (e.g., operator(s)) and/or well testing devices. Examples disclosed herein generate workflows that maximize efficiency for performing the tasks by a minimum number of users and/or devices and that include margins to accommodate unexpected or unplanned events that cause additional tasks to be performed. Examples disclosed herein deliver the workflow(s) in substantially real-time during the well test to user device(s) and/or well testing device(s) and monitor for completion of the tasks and/or the occurrence of unplanned events during the well test. Based on the monitoring, examples disclosed herein dynamically adjust the workflow(s) in substantially real-time to respond to delays in task completion and/or unexpected events at the wellsite to mitigate potential disruptions to the completion of the well test. Examples disclosed herein intelligently and dynamically respond to conditions at a wellsite that can affect well testing operations to provide for efficient execution of the well test tasks.

An example apparatus includes an optimizer to generate a first workflow to be executed by a first user during a well test at a well. The example apparatus includes a workflow adjuster to selectively adjust at least one of the first workflow to generate a first adjusted workflow or a second workflow to generate a second adjusted workflow based on a notice indicative of an unplanned event at the well. The second workflow is to be associated with a second user or a well test device. The example apparatus includes a communicator to transmit one or more of the first adjusted workflow to a user device or the second adjusted workflow to a user device or the well test device during the well test.

In some examples, the workflow adjuster is to selectively adjust the first workflow or the second workflow based on respective availabilities of the first user or the second user.

In some examples, the workflow adjuster is to selectively adjust the first workflow or the second workflow based on respective training levels of the first user or the second user.

In some examples, the first workflow includes a first task to be performed by the first user during the well test and the workflow adjuster is to adjust the first workflow by adding a second task to the first workflow. In some such examples, the first workflow includes a third task, the workflow adjust to further adjust the first workflow by removing the third task from the first workflow based on the adding of the second task to the first workflow.

In some examples, the workflow adjuster is to receive the notice from at least one of the user device or the well test device.

In some examples, the apparatus further includes a feedback analyzer, and the feedback analyzer is to analyze the adjustment to the at least one of the first workflow or the second workflow and update a workflow adjustment rule based on the analysis, the workflow adjuster to adjust a third workflow based on the updated workflow adjustment rule.

In some examples, the apparatus further includes a task allocator to generate a task allocation scenario for the first user and the optimizer is to generate the first workflow based on the task allocation scenario.

An example method includes generating a first workflow to be executed by a first user during a well test at a well. The example method includes selectively adjusting at least one of the first workflow to generate a first adjusted workflow or a second workflow to generate a second adjusted workflow based on a notice indicative of an unplanned event at the well. The second workflow is to be associated with a second user or a well test device. The example method includes transmitting one or more of the first adjusted workflow to a user device or the second adjusted workflow to a user device or the well test device during the well test.

In some examples, the method further includes selectively adjusting the first workflow or the second workflow based on respective availabilities of the first user or the second user.

In some examples, the method further includes selectively adjusting the first workflow or the second workflow based on respective training levels of the first user or the second user.

In some examples, the first workflow includes a first task to be performed by the first user during the well test and the adjusting of the first workflow includes adding a second task to the first workflow. In some such examples, the first workflow includes a third task and the method further includes removing the third task from the first workflow based on the adding of the second task to the first workflow.

In some examples, the method further includes generating a task allocation scenario for the first user, the generating of the first workflow to be based on the task allocation scenario.

An example non-transitory computer readable medium includes instructions that, when executed, cause a machine to generate a first workflow to be executed by a first user during a well test at a well. The instructions cause the machine to selectively adjust at least one of the first workflow to generate a first adjusted workflow or a second workflow to generate a second adjusted workflow based on a notice indicative of an unplanned event at the well. The second workflow is to be associated with a second user or a well test device. The instructions cause the machine to transmit one or more of the first adjusted workflow to a user device or the second adjusted workflow to a user device or the well test device during the well test.

In some examples, the instructions, when executed, further cause the machine to selectively adjust the first workflow or the second workflow based on respective availabilities of the first user or the second user.

In some examples, the instructions, when executed, further cause the machine to the first workflow or the second workflow based on respective training levels of the first user or the second user.

In some examples, the first workflow includes a first task to be performed by the first user during the well test and the instructions, when executed, cause the machine to adjust the first workflow by adding a second task to the first workflow.

In some examples, the first workflow includes a third task and the instructions, when executed, cause the machine to remove the third task from the first workflow based on the adding of the second task to the first workflow.

In some examples, the instructions, when executed, further cause the machine generate a task allocation scenario for the first user and generate the first workflow based on the task allocation scenario.

In the specification and appended claims: the terms “connect,” “connection,” “connected,” “connecting,” and/or other variations thereof are used to mean “in direct connection with” or “in connection with via one or more elements.” Further, the terms “couple,” “coupling,” “coupled,” and “coupled to” and/or other variation thereof are used to mean “directly coupled together” or “coupled together via one or more elements.”

The foregoing outlines features of several embodiments so that those skilled in the art may better understand aspects of the present disclosure. Those skilled in the art should appreciate that they may readily use the present disclosure as a basis for designing or modifying other processes and structures for carrying out the same purposes or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

Although the preceding description has been described herein with reference to particular means, materials and embodiments, it is not intended to be limited to the particulars disclosed herein; rather, it extends to all functionally equivalent structures, methods, and uses, such as are within the scope of the appended claims.

1. An apparatus comprising:
an optimizer to generate a first workflow to be executed by a first user during a well test at a well;
a workflow adjuster to selectively adjust at least one of the first workflow to generate a first adjusted workflow or a second workflow to generate a second adjusted workflow based on a notice indicative of an unplanned event at the well, the second workflow to be associated with a second user or a well test device; and
a communicator to transmit one or more of the first adjusted workflow to a user device or the second adjusted workflow to a user device or the well test device during the well test.

2. The apparatus of claim 1, wherein the workflow adjuster is to selectively adjust the first workflow or the second workflow based on respective availabilities of the first user or the second user.

3. The apparatus of claim 1, wherein the workflow adjuster is to selectively adjust the first workflow or the second workflow based on respective training levels of the first user or the second user.

4. The apparatus of claim 1, wherein the first workflow includes a first task to be performed by the first user during the well test and the workflow adjuster is to adjust the first workflow by adding a second task to the first workflow.

5. The apparatus of claim 4, wherein the first workflow includes a third task, the workflow adjust to further adjust the first workflow by removing the third task from the first workflow based on the adding of the second task to the first workflow.

6. The apparatus of claim 1, wherein the workflow adjuster is to receive the notice from at least one of the user device or the well test device.

7. The apparatus of claim 1, further including a feedback analyzer, the feedback analyzer to:
analyze the adjustment to the at least one of the first workflow or the second workflow; and
update a workflow adjustment rule based on the analysis, the workflow adjuster to adjust a third workflow based on the updated workflow adjustment rule.

8. The apparatus of claim 1, further including a task allocator to generate a task allocation scenario for the first user, the optimizer to generate the first workflow based on the task allocation scenario.

9. A method comprising:
generating a first workflow to be executed by a first user during a well test at a well;
selectively adjusting at least one of the first workflow to generate a first adjusted workflow or a second workflow to generate a second adjusted workflow based on a notice indicative of an unplanned event at the well, the second workflow to be associated with a second user or a well test device; and
transmitting one or more of the first adjusted workflow to a user device or the second adjusted workflow to a user device or the well test device during the well test.

10. The method of claim 1, further including selectively adjusting the first workflow or the second workflow based on respective availabilities of the first user or the second user.

11. The method of claim 9, further including selectively adjusting the first workflow or the second workflow based on respective training levels of the first user or the second user.

12. The method of claim 9, wherein the first workflow includes a first task to be performed by the first user during the well test and the adjusting of the first workflow includes adding a second task to the first workflow.

13. The method of claim 12, wherein the first workflow includes a third task and further including removing the third task from the first workflow based on the adding of the second task to the first workflow.

14. The method of claim 9, further including generating a task allocation scenario for the first user, the generating of the first workflow to be based on the task allocation scenario.

15. A non-transitory computer readable storage medium comprising instructions that, when executed, cause a machine to:
generate a first workflow to be executed by a first user during a well test at a well;
selectively adjust at least one of the first workflow to generate a first adjusted workflow or a second workflow to generate a second adjusted workflow based on a notice indicative of an unplanned event at the well, the second workflow to be associated with a second user or a well test device; and
transmit one or more of the first adjusted workflow to a user device or the second adjusted workflow to a user device or the well test device during the well test.

16. The non-transitory computer readable storage medium of claim 15, wherein the instructions, when executed, further cause the machine to selectively adjust the first workflow or the second workflow based on respective availabilities of the first user or the second user.

17. The non-transitory computer readable storage medium of claim 15, wherein the instructions, when executed, further cause the machine to the first workflow or the second workflow based on respective training levels of the first user or the second user.

18. The non-transitory computer readable storage medium of claim 15, wherein the first workflow includes a first task to be performed by the first user during the well test and the instructions, when executed, cause the machine to adjust the first workflow by adding a second task to the first workflow.

19. The non-transitory computer readable storage medium of claim 18, wherein the first workflow includes a third task and the instructions, when executed, cause the machine to remove the third task from the first workflow based on the adding of the second task to the first workflow.

20. The non-transitory computer readable storage medium of claim 15, wherein the instructions, when executed, further cause the machine generate a task allocation scenario for the first user and generate the first workflow based on the task allocation scenario.
